(19) United States
(12) Patent Application Publication
(10) Pub. No.: US 2026/0316324 A1
(43) Pub. Date: Oct. 15, 2026

(54) DRIVING AND CENTERING MECHANISM AND SYSTEM WITH CLOSED LOOP CONTROL FOR A DEBARKER AND FEEDROLLS FOR A DEBARKER

(71) Applicant: Nicholson Manufacturing Ltd., Sidney (CA)

(72) Inventors: James Buckley BOWDEN, Victoria (CA); Adam Richard BROWN, Valley Grande, AL (US); Jorgen Carl LEFSRUD, Salt Spring Island (CA); Michael Robert MASON, Central Saanich (CA); Nigel Arthur WEBB, Victoria (CA)

(21) Appl. No.: 19/481,404

(22) PCT Filed: Apr. 30, 2024
(86) PCT No.: PCT/US2024/026977

§ 371 Date: Nov. 4, 2025

Related U.S. Application Data
(60) Provisional application No. 63/500,460, filed on May 5, 2023.

(51) Int. Cl. B27L 1/08

(52) U.S. Cl. CPC B27L 1/08

(57) ABSTRACT

A hydraulic circuit including a closed loop control circuit. The closed loop control circuit is configured to, in operation, control a plurality of rollers. The respective rollers of the plurality of rollers are pre-positioned in advance of a respective log entering a centering mechanism or system of a debarker. The closed loop control circuit is configured to, in operation, maintain a target pressure within the closed loop control circuit to maintain physical contact of the plurality of rollers with an external surface with the respective log as the respective log passes through and between the plurality of rollers of the centering mechanism or system and into the debarker to remove bark from the respective log.

### BACKGROUND

### Technical Field

The present disclosure is directed to a log-centering mechanism and system including a closed loop control to control a centering mechanism and system as logs pass through the centering mechanism and system.

### Description of the Related Art

Generally, debarkers include one or more rollers that direct a log through the debarker such that bark of the log may be removed from the log by one or more debarker cutters. Open loop control systems present within the debarkers generally make estimations and assumptions that are utilized to control the one or more rollers. In operation, the one or more rollers are configured to position the log in a relatively centralized position as the log passes through debarker to have the bark removed from the log. In the open loop control system that controls the one or more rollers, there is no measured positional feedback with respect to the position of the one or more rollers or the log as the log passes through the one or more rollers into the debarker.

### BRIEF SUMMARY

The present disclosure is directed to providing a centering mechanism or system with one or more rollers that are controlled by a closed loop control system to direct a log through a debarker, which is configured to, in operation, remove bark from the log passing through the debarker. The centering mechanism or system of the present disclosure may be utilized for other types of machines or mechanisms for refining logs into timber such as a rotary cutter mechanism, a variable flare reducer, or some other similar or like types of machines and mechanisms for processing logs.

For example, in at least one embodiment of the present disclosure, a centering mechanism or system of a debarker includes a plurality of rollers and a closed loop control circuit that is utilized to pre-position the plurality of rollers in advance of a log entering the centering mechanism or system. The closed loop control circuit may further be utilized and configured to, in operation, maintain physical contact between the plurality of rollers and an external surface of the log to properly center and direct the log into the debarker to remove bark from the log.

Unlike open loop control systems that may only utilize a previous diameter of a previous log that already passed through a centering mechanism or system to determine positioning of various components of the debarker such as directional rollers of the centering mechanism or system, the at least one embodiment of the centering mechanism or system with the closed loop control system monitors and determines a position of a hydraulic actuator and a pressure within the hydraulic actuator in real time. This pressure and positional information with respect to the hydraulic actuator allows for the centering mechanism or system to be configured to, in operation, control a position of a plurality of rollers of the centering mechanism in real time such that the plurality of rollers may be positioned more accurately and precisely. This feedback and information with respect to the position of and the pressure within the hydraulic actuator is analyzed by a controller such that the plurality of rollers may be pre-positioned or positioned in advance of a respective log entering the debarker, and such that a constant pressure (e.g., a target pressure) is maintained within the hydraulic actuator resulting in a constant force being applied to an outer surface of the respective log by the rollers as the respective log passes through the centering mechanism or system. This pre-positioning or positioning of the plurality of rollers and the constant force being applied to the outer surface of the respective log by the plurality of rollers improves centering of the respective log as the respective log passes into and through the debarker increasing efficiency and speed at which the debarker may remove bark from the respective log. This pre-positioning or positioning of the plurality of rollers and the constant force being applied to the outer surface of the respective log by the plurality of rollers may reduce the likelihood of damage to the centering mechanism or system or the respective log when the respective log is passing into and through the centering mechanism or system. The present disclosure is further directed to a driving mechanism or system with one or more feedrolls that are controlled utilizing the closed loop control system as discussed above.

The present disclosure is directed to various embodiments of feedrolls that may be utilized in the driving mechanism or system to drive respective logs through a debarker. In at least some embodiments of the feedrolls of the present disclosure, the feedrolls include a chain insert and a barrel to which the chain insert is mounted. The chain insert may be removed from the barrel such that the chain insert may be replaced without having to replace the entire feedroll. The chain insert being replaceable reduces downtime by reducing maintenance time when replacing the chain insert with a new chain insert.

### BRIEF DESCRIPTION OF THE SEVERAL VIEWS OF THE DRAWINGS

For a better understanding of the embodiments, reference will now be made by way of example to the accompanying drawings. In the drawings, identical reference numbers identify the same or similar elements or acts unless the context indicates otherwise. The sizes and relative proportions of the elements in the drawings are not necessarily drawn to scale. For example, some of these elements may be enlarged and positioned to improve drawing legibility.

FIG. 1A is a perspective view of an embodiment of a centering mechanism or system of a debarker of the present disclosure;

FIG. 1B is a front side view of the embodiment of the centering mechanism or system of the debarker as shown in FIG. 1A;

FIG. 1C is a front side view of the embodiment of the centering mechanism or system of the debarker as shown in FIG. 1A when a respective log is passing through the centering mechanism or system of the debarker;

FIG. 1D is a front side view of the embodiment of the centering mechanism or system of the debarker as shown in FIG. 1A with hidden lines shown to illustrate internal components of the centering mechanism or system as shown in FIG. 1A;

FIG. 1E is a front side view of the embodiment of the centering mechanism or system of the debarker as shown in FIG. 1A with a frame of the centering mechanism or system hidden to illustrate the internal components of the centering mechanism or system as shown in FIG. 1D;

FIG. 1F is a rear side view of the embodiment of the centering mechanism or system of the debarker as shown in FIG. 1A;

FIG. 2 is a representation of an embodiment of a log scanning mechanism or system of the debarker that is upstream of the centering mechanism or system of the debarker as shown in FIG. 1A;

FIG. 3 is an embodiment of a hydraulic circuit schematic including a closed loop control system incorporated within the centering mechanism or system of the debarker as shown in FIG. 1A;

FIG. 4 is an alternative embodiment of a hydraulic circuit schematic including a closed loop control system incorporated within the centering mechanism or system of the debarker as shown in FIG. 1A;

FIG. 5 is a flowchart of a method of controlling a plurality of rollers of the embodiment of the centering mechanism as shown in FIGS. 1A-1F of the present disclosure including at least one of the respective embodiments of a hydraulic circuit including a closed loop control system as shown in FIGS. 3 and 4 of the present disclosure;

FIG. 6A is a perspective view of an embodiment of a driving mechanism or system of a debarker of the present disclosure;

FIG. 6B is a right side view of the embodiment of the driving mechanism or system of the debarker as shown in FIG. 6A;

FIG. 6C is a left side view of the embodiment of the driving mechanism or system of the debarker as shown in FIGS. 6A and 6B;

FIG. 6D is a rear view of the embodiment of the driving mechanism or system of the debarker as shown in FIGS. 6A-6C;

FIG. 6E is a front view of the embodiment of the driving mechanism or system of the debarker as shown in FIG. 6A-6D;

FIG. 6F is a perspective view of the embodiment of the driving mechanism or system of the debarker as shown in FIGS. 6A-6E;

FIG. 7A is a perspective view of an alternative embodiment of a driving mechanism or system of a debarker of the present disclosure;

FIG. 7B is a rear view of the alternative embodiment of the driving mechanism or system of a debarker of the present disclosure;

FIG. 8A is a perspective view of an embodiment of a chain feedroll of the present disclosure with a chain mounted to a barrel of the embodiment of the chain feedroll;

FIG. 8B is a perspective view of the embodiment of the chain feedroll of the present disclosure as shown in FIG. 8A with the chain removed from the barrel of the embodiment of the chain feedroll;

FIG. 8C is a side view of the embodiment of the chain feedroll of the present disclosure as shown in FIGS. 8A and 8B;

FIG. 8D is a top view of the embodiment of the chain feedroll of the present disclosure as shown in FIG. 8A-8C;

FIG. 8E is a zoomed in and enhanced view of section E-E as shown in FIG. 8D of the embodiment of the chain feed roll of the present disclosure as shown in FIGS. 8A-8D;

FIG. 9A is a perspective view of an alternative embodiment of a chain feedroll of the present disclosure with a chain mounted to a barrel of this alternative embodiment of the chain feedroll;

FIG. 9B is a perspective view of the alternative embodiment of the chain feedroll of the present disclosure as shown in FIG. 9A with the chain removed from the barrel;

FIG. 10A is a perspective view of an alternative embodiment of a feedroll of the present disclosure;

FIG. 10B is cross-sectional view of the alternative embodiment of the feedroll as shown in FIG. 10A taken along line B-B as shown in FIG. 10A;

FIG. 11 is a perspective view of an alternative embodiment of a chain insert portion or flute of the present disclosure.

### DETAILED DESCRIPTION

In the following description, certain specific details are set forth in order to provide a thorough understanding of various embodiments of the disclosure. However, one skilled in the art will understand that the disclosure may be practiced without these specific details. In other instances, well-known structures associated with debarkers and debarker knife tips have not been described in detail to avoid unnecessarily obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

The use of ordinals such as first, second, third, etc., does not necessarily imply a ranked sense of order, but rather may only distinguish between multiple instances of an act or a similar structure or material.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms “left,” “right,” “top,” “bottom,” “upper,” or “lower” are used for only discussion purposes based on the orientation of the components in the discussion of the Figures in the present disclosure as follows. These terms are not limiting as to the possible positions explicitly disclosed, implicitly disclosed, or inherently disclosed in the present disclosure.

As used in this specification and the appended claims, the singular forms “a,” “an,” and “the” include plural referents unless the content clearly dictates otherwise.

While various embodiments are shown and described with respect to debarker centering mechanisms and systems, it will be readily appreciated that embodiments of the present disclosure are not limited thereto. In various embodiments, the structures, devices, methods and the like described herein may be embodied in or otherwise utilized in any suitable type or form of a centering mechanism or systems to be utilized within a debarker.

Generally, debarkers include a centering mechanism or system including an open loop control system to center a respective log as the respective log passes into and through a debarker. Centering the respective log with a plurality of rollers that are positioned by the open loop control circuit or system in advance of the time of entry of the respective log into the debarker allows the debarker to remove bark properly, effectively and efficiently in preparing the respective log to be converted into lumber, timber, or some other similar or like type of wood product. For example, this open loop control system may include a scanning system, which may be upstream of the centering mechanism or system, which is configured to, in operation, scan the respective log to determine a first diameter of the respective log in advance of the respective log passing between the plurality of rollers. This first diameter of the respective log to pass between the plurality of rollers may be utilized in combination with a second diameter of a previous respective log that passed through the centering mechanism or system shortly before the respective log passes into and through the centering mechanism or system. This second diameter of the previous respective log is utilized to determine a determined position of the plurality of rollers in advance of the respective log entering the centering mechanism or system. The plurality of rollers is then actuated or moved from the determined position based on the second diameter to a pre-position or an initial position in advance of the respective log entering between the plurality of rollers of the centering mechanism or system based on a measurement of the first diameter of the respective log. However, as no log has a uniform or consistent diameter (i.e., a diameter of a log may be different along various points of a length of a log), utilizing the second diameter to determine the determined position of the plurality of rollers in advance of the respective log passing through the centering mechanism or system may not be accurate or precise. This inaccuracy of the open loop control system in determining the determined position of the plurality of rollers with the second diameter of the previous log debarked by the debarker may result in the plurality of rollers not properly contacting an outer surface of the respective log such that the respective log with the first diameter is not properly centered when entering the debarker. This improper centering of the respective log with the first diameter as it enters the debarker may result in damage to the debarker, thereby increasing maintenance costs, may result in damage to the log, thereby decreasing yield, or may result in other similar or like types of issues that may increase costs when debarking logs utilizing the debarker with the open loop control system.

At least one embodiment of a centering mechanism or system of the present disclosure includes a closed loop control system such that positioning of a plurality of rollers, or the centering mechanism or system, may be monitored in real time. This real-time monitoring of the position of the plurality of rollers in the at least one embodiment of the centering mechanism or system of the present disclosure utilizing the closed loop control system provides a more accurate determination of the position of the plurality of rollers relative to a centering mechanism or system having an open loop control system as discussed above. For example, the at least one embodiment of the centering mechanism of the present disclosure may include at least one pressure transducer that monitors at least one pressure within a hydraulic circuit of the at least one embodiment of the centering mechanism or system, and at least one positional transducer that monitors a position of a piston rod of a hydraulic cylinder or piston that is configured to, in operation, control positions of the plurality of rollers of the at least one embodiment of the centering mechanism or system of the present disclosure. In some alternative embodiments, the at least one positional transducer may be utilized along with at least one angle transducer or some other type of transducer or sensor to monitor the various components of the centering mechanism or system in a closed loop control system. In some alternative embodiments, the at least one positional transducer may be switched out for at least one angle transducer or some other type of transducer or sensor to monitor the various components of the centering mechanism or system in a closed loop control system. For example, the at least one angle transducer may monitor an angular position of one or more rollers of the plurality of rollers to control an actuator (e.g., the hydraulic cylinder or piston) for controlling and positioning the plurality of rollers.

The closed loop control system of the present disclosure may reduce an amount of movement required to move arms to position the plurality of rollers utilizing the closed loop control system as the arms are positioned more accurately relative to when utilizing the opened loop control system as discussed above. This reduction in movement of the plurality of rollers and arms utilizing the closed loop control system instead of the opened loop control system may provide reduction in energy costs as there is reduction in the amount of energy utilized as the plurality of rollers are moved more accurately utilizing the closed loop control system instead of the opened loop control system.

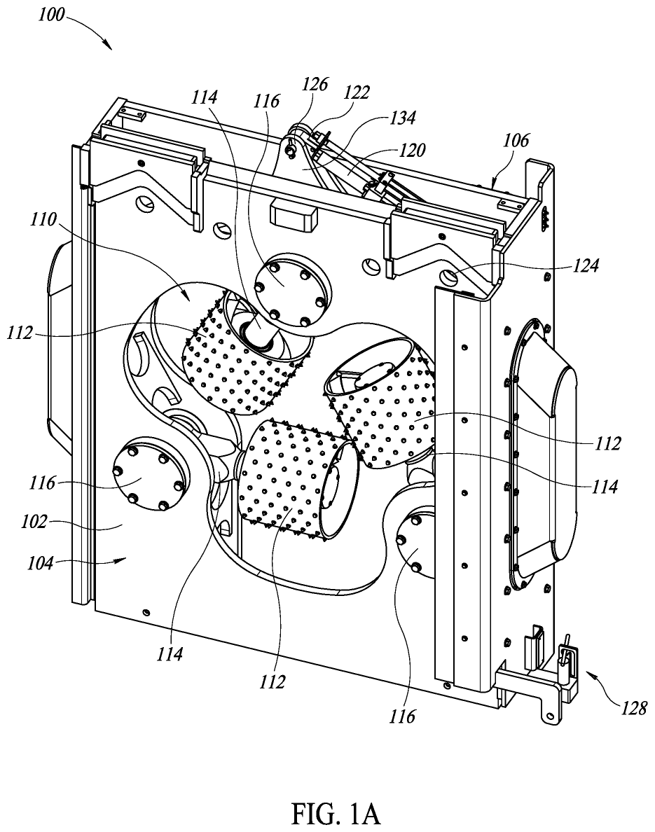

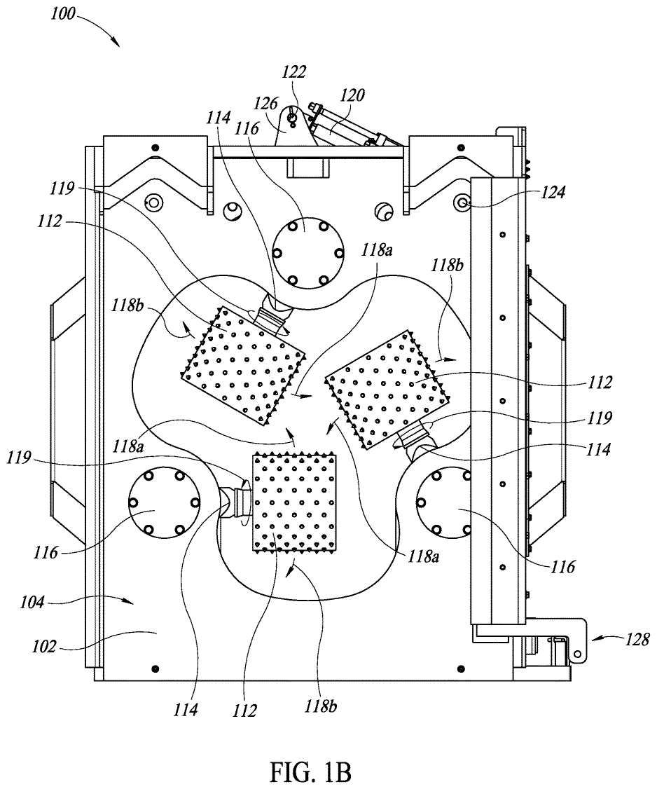

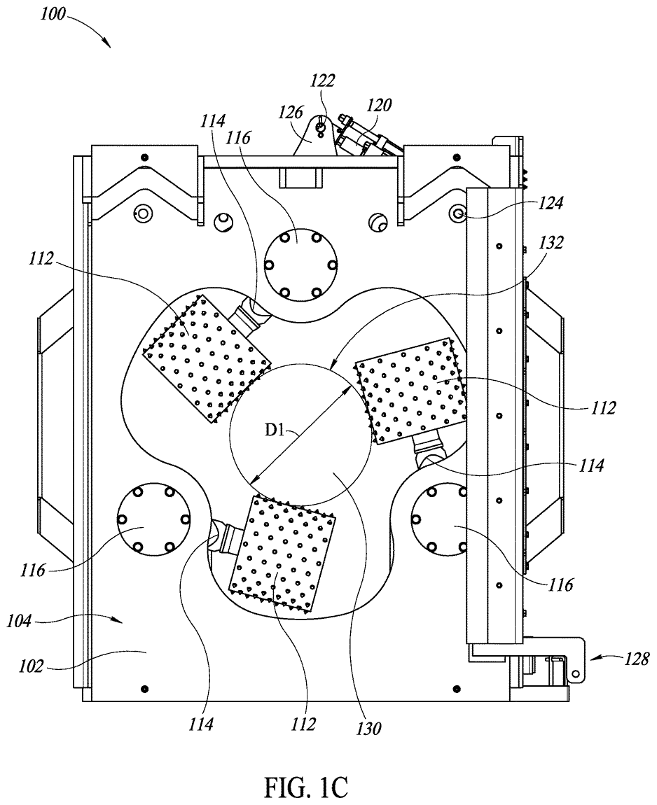

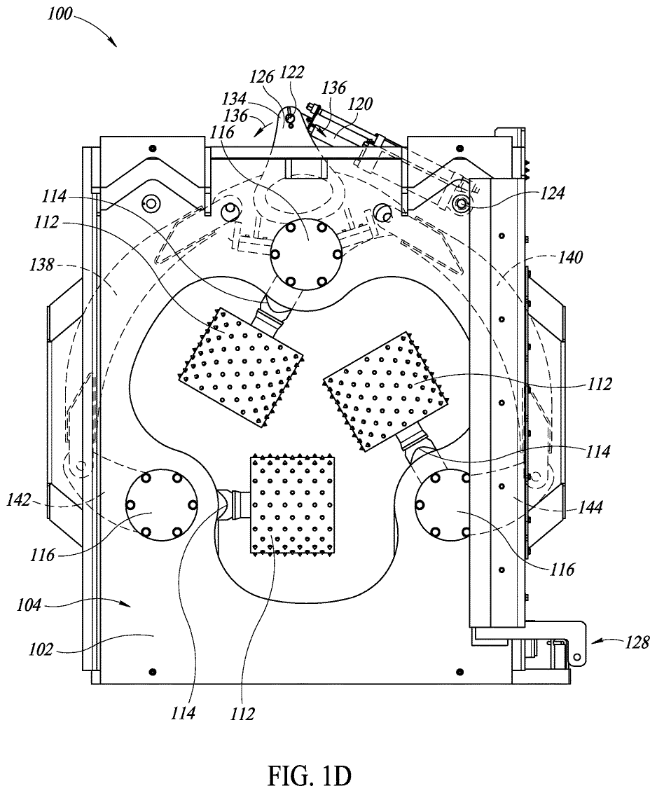

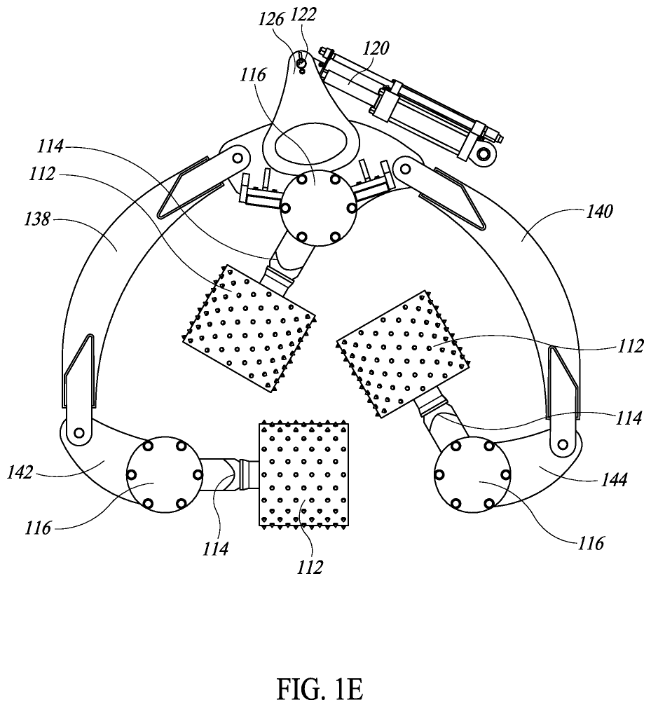

FIG. 1A is a perspective view of an embodiment of a centering mechanism or system 100 of the present disclosure. For simplicity and brevity of the present disclosure, the centering mechanism or system 100 will be referred to as a centering system 100 herein. While not shown, the centering system 100 may be one of a plurality of systems within a debarker (not shown) that is configured to, in operation, debark a plurality of logs successively as each respective log of the plurality of logs passes through the debarker.

A frame 102 of the centering system 100 includes an inlet side 104 (see FIG. 1B of the present disclosure) and an outlet side 106 (see FIG. 1E of the present disclosure) opposite to the inlet side 104. Each respective log of a plurality of logs that is to be debarked by the debarker successively passes through the centering system 100 such that each respective log of the plurality of logs passes through an opening 110, which extends from the inlet side 104 to the outlet side 106 of the centering system 100. In the at least one embodiment of the centering system 100 as shown in FIG. 1A, the opening 110 has a shape similar to a three-leaf clover. In some alternative embodiments, the opening 110 may have some other polygonal or different shape than the shape of the opening 110 as shown in FIG. 1A.

A plurality of rollers 112 of the centering system 100 is present within the opening 110. A plurality of arms 114 is coupled to the plurality of rollers 112 such that each respective roller of the plurality of rollers 112 is coupled to a respective first end of a corresponding arm of the plurality of arms 114. Each respective arm of the plurality of arms 114 includes a respective second end that is opposite to the corresponding respective first end. Each respective second end of each respective arm of the plurality of arms 114 is in mechanical cooperation with a corresponding pivot of a plurality of pivots 116, which may be referred to as pivot points, about which each respective arm of the plurality of arms 114 pivots to rotate and translate the plurality of rollers 112. This rotation and translation of the plurality of rollers 112 may be directed towards (e.g., inwards) and away from (e.g., outwards) a center of the opening 110. This rotational and translation movement of the plurality of rollers 112 is represented by respective arrows 118a, 118b (see FIG. 1B). First arrows 118a of the respective arrows 118a, 118b represent inward movement of the plurality of rollers 112 towards the center of the opening 110, and second arrows 118b of the respective arrows 118a, 118b represent outward movement of the plurality of rollers 112 away from the center of the opening 110.

The plurality of rollers 112 includes protrusions or extensions (i.e., nipples or spikes) that may increase friction by reducing contact area of the plurality of rollers 112 with an external surface of a respective log as the respective log passes through and between the plurality of rollers 112. In at least one embodiment, the plurality of rollers 112 rotate freely about the plurality of arms 114. This free rotation of the plurality of rollers 112 about the plurality of arms 114 allows for the rollers to roll freely along the external surface of the respective log as the respective log passes through and between the plurality of rollers 112. This free rotation of the plurality of rollers 112 about the plurality of arms 114 is represented by arrows 119 (see FIG. 1B).

The protrusions or extension (i.e., nipples or spikes) of the plurality of rollers 112 increases grip or traction between the respective log passing through and between the plurality of rollers 112. This increased grip or traction counteracts torque generated from the debarking or flare reducing ring rotation when processing the respective logs passing through the debarker that includes the centering system 100.

In at least one alternative embodiment, the plurality of rollers 112 may be driven by an actuator (e.g., a motor) such that the plurality of rollers 112 may assist in feeding the respective log through the centering system 100 as the respective log passes through the plurality of rollers 112.

A hydraulic cylinder or piston 120 is present at an upper end of the frame 102 of the centering system 100. The hydraulic cylinder 120 is configured to, in operation, extend and retract to rotate and translate the plurality of rollers 112 between various positions, which will be discussed in detail later herein. The hydraulic cylinder 120 has a first end 122 and a second end 124 opposite to the first end 122. While the hydraulic cylinder or piston 120 is present at the upper end of the frame 102, in some embodiments, the hydraulic cylinder or piston 120 may be at some other location along the frame 102 of the centering system 100.

A mechanical linkage, structure, or assembly 126 is in mechanical cooperation with the second end 124 of the hydraulic piston 120. The mechanical linkage 126 is configured to, in operation, mechanically communicate or transfer a linear movement (i.e., extension or retraction) of the hydraulic piston 120 such that the plurality of rollers 112 rotate or translate between various positions along various directions as represented by the respective arrows 118a, 118b. Further details of the mechanical linkage, structure, or assembly 126 will be discussed later herein with respect to FIGS. 1D and 1F.

A mounting structure 128 may be present at a corner of the frame 102, which is located at a lower end of the frame 102. The mounting structure 128 may be utilized to lock the centering system 100 within the debarker. For example, when the mounting structure 128 is locked to the debarker, the centering system 100 is locked within the debarker. When the centering system 100 is to be maintained or is desired to be removed from the debarker, the mounting structure 128 may be unlocked such that the centering system 100 may slide out of the debarker. In other words, the centering system 100 may slide into and out of the debarker, and the centering system 100 may be locked into place within the debarker utilizing the mounting structure 128.

FIG. 1B is a front side view of the centering system 100 as shown in FIG. 1A. As shown in FIG. 1B, the second end 124 of the hydraulic piston 120 is fixedly and stationarily mounted. For example, in some embodiments, the second end 124 of the hydraulic piston 120 may be fixedly and stationarily coupled to the frame 102 of the centering system 100.

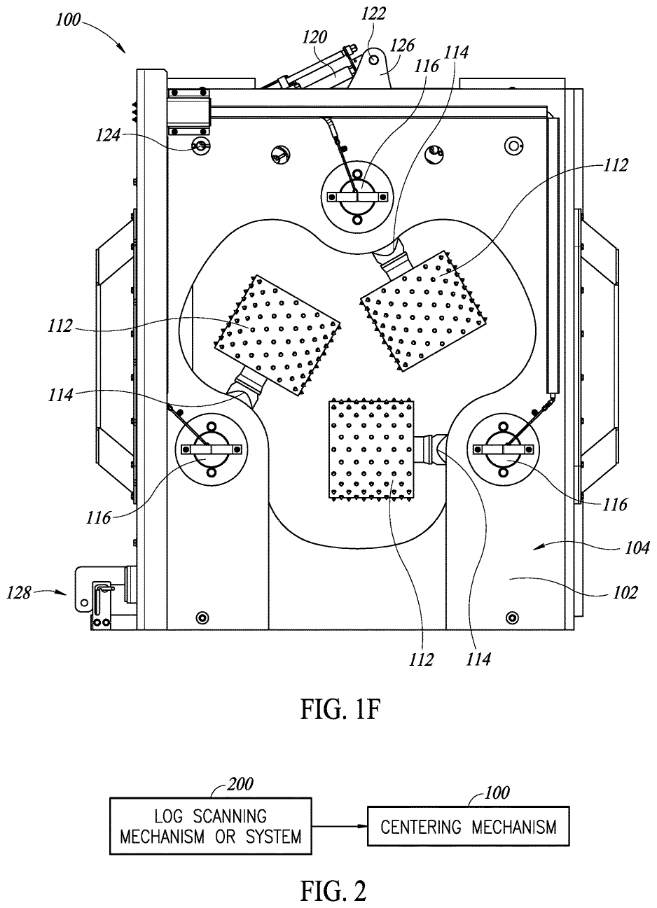

FIG. 1C is a front side view of the centering system 100 as shown in FIG. 1A in which a respective log 130 is present between the plurality of rollers 112. The respective log 130 has a diameter D1. The respective log 130 includes an external or outer surface 132 which the plurality of rollers 112 physically contact and abut as the respective log 130 passes through and between the plurality of rollers 112 of the centering system 100 when entering the debarker to be debarked (i.e., remove bark from the log 130). As the respective log 130 passes through and between the plurality of rollers 112 of the centering system 100, the plurality of rollers 112 freely rotating about the plurality of arms 114 as represented by the arrows 119 (see FIG. 1B) and rotate and translate inward and outward as represented by the arrows 118a, 118b as the diameter D1 of the respective log may fluctuate along a length of the log that is parallel to the external surface 132 of the respective log 130. This free rotation of the plurality of rollers 112 and translational and rotational movement of the plurality of rollers 112 allows for the respective log 130 to enter the debarker in a centralized position to more properly, effectively and efficiently remove the bark from the respective log 130. The details of this process will be described further with respect to FIGS. 2, 3, and 4 of the present disclosure later herein.

FIG. 1D is a front side view of the centering system 100 as shown in FIG. 1A with hidden lines shown to illustrate internal components of the centering system 100 as shown in FIG. 1A. FIG. 1E is a front side view of the centering system 100 as shown in FIG. 1A with the frame 102 hidden such that the internal components of the centering system 100 are more readily visible.

The mechanical linkage 126 includes a first portion 134 in mechanical cooperation with the first end 122 of the hydraulic piston 120. Rotation of the first portion 134 of the mechanical linkage 126 is represented by respective arrows 136. For example, as the hydraulic piston 120 is extended and retracted the first portion 134 is rotated by this extension and retraction of the hydraulic piston 120 due to the first portion 134 being in mechanical cooperation with the first end 122 of the hydraulic piston 120. For example, as the hydraulic piston 120 is retracted, the first portion 134 is rotated in a clockwise direction as represented by the arrows 136, and, oppositely, as the hydraulic piston 120 is extended, the first portion 134 is rotated in a counterclockwise direction as represented by the arrows 136.

In at least one alternative embodiment, the hydraulic piston 120 may be replaced with another type of actuator. For example, in at least one alternative embodiment, the hydraulic piston 120 may be replaced with a rotary actuator or angular actuator that may rotate the plurality of arms 114 to position the plurality of rollers. In other words, while a hydraulic piston 120 may be utilized in the embodiment as shown in FIGS. 1A-1F, other types of actuators may be utilized to actuate the plurality of rollers 112 and pre-position or position the plurality of rollers 112 as discussed herein.

In at least one alternative embodiment, the plurality of rollers 112 may be independently movable such that each roller may be positioned independently from each other. This independent positioning of each one of the plurality of rollers 112 may provide increased contact with the respective log as the respective log is centered by the centering mechanism or system 100.

The first portion 134 of the mechanical linkage 126 is in mechanical cooperation with a first pair of curved portions 138, 140 that includes a first curved portion 138 at the left-hand side as shown in FIGS. 1D and 1E and a second curved portion 140 at the right-hand side as shown in FIGS. 1D and 1E based on the orientation of the centering system 100 as shown in FIGS. 1D and 1E. The first portion 134 of the mechanical linkage 126 is in mechanical cooperation with an uppermost pivot of the plurality of pivots 116. A second pair of curved portions 142, 144 includes a third curved portion 142 and a fourth curved portion 144. The third curved portion 142 is in mechanical cooperation with the first curved portion 138 and is in mechanical cooperation with a leftmost pivot of the plurality of pivots 116, and the fourth curved portion 144 is in mechanical cooperation with the second curved portion 140 and is in mechanical cooperation with a rightmost pivot of the plurality of pivots 116. In some embodiments, the first and second pairs of curved portions 138, 140, 142, 144 may be more linearly shaped than curved but still provide and allow the rotational and translational movement as represented by the arrows 118a, 118b, respectively.

When the first portion 134 is rotated in the clockwise direction as represented by the arrows 136, the first portion 134 mechanically communicates or transfers motion to the first pair of curved portions 138, 140 and the uppermost pivot of the plurality of pivots 116. Motion of the first pair of curved portions 138, 140 mechanically communicates or transfers motion to the second pair of curved portions 142, 144. The respective motion, translation, and rotation of the first portion 134, the first pair of curved portions 138, 140, and the second pair of curved portions 142, 144 of the mechanical linkage 126 results in each respective arm of the plurality of arms 114 rotating about a corresponding pivot of the plurality of pivots 116. As the plurality of rollers 112 is coupled to the plurality of arms 114, the plurality of rollers 112 is translated and rotated outward and away from the center of the opening 110.

When the first portion 134 is rotated in the counterclockwise direction as represented by the arrows 136, the first portion 134 mechanically communicates or transfers motion to the first pair of curved portions 138, 140 and the uppermost pivot of the plurality of pivots 116. Motion of the first pair of curved portions 138, 140 mechanically communicates or transfers motion to the second pair of curved portions 142, 144. The respective motion, translation, and rotation of the first portion 134, the first pair of curved portions 138, 140, and the second pair of curved portions 142, 144 of the mechanical linkage 126 results in each respective arm of the plurality of arms 114 rotating about a corresponding pivot of the plurality of pivots 116. As the plurality of rollers 112 is coupled to the plurality of arms 114, the plurality of rollers 112 is translated and rotated inward and towards the center of the opening 110.

FIG. 1F is a rear side view of the embodiment of the centering system 100 of the debarker as shown in FIG. 1A.

FIG. 2 is a representation of an embodiment of a log scanning mechanism or system 200 of the debarker that is upstream of the centering system 100 of the debarker as shown in FIGS. 1A-1F. In some embodiments, the log scanning mechanism or system 200 may be downstream the centering system 100 of the debarker. As shown in FIG. 2, the log scanning system 200 is upstream of the centering system 100. The log scanning system 200 is configured to, in operation, scan each respective log of a plurality of respective logs that is to pass through the centering system 100 and into the debarker to remove bark from the plurality of respective logs. The log scanning system 200 may include one or more image sensors or image capture devices that are coupled to a log scanning controller to determine various measurements of each of the respective logs. For example, these measurements may be a length of a respective log, one or more diameters of a respective log, or some other type of measurement with respect to the respective log. These measurements and data collected with respect to the respective logs may be utilized to pre-position the plurality of rollers 112 with respect to each of the respective logs before each of the respective logs enters the debarker through the centering system 100 and passes between the plurality of rollers 112 of the centering system 100.

In some embodiments, the log scanning system 200 may include an off-center detection mechanism, device, or system that may monitor and determine if any of the respective logs are substantially off-center with respect to the centering system 100. For example, in advance of one of the respective logs entering the centering system 100 and passing between the plurality of rollers 112, the off-center detection system may output an off-center signal. This outputting of the off-center signal results in an off-center adjustment structure or system (not shown) moving or adjusting the one of the respective logs into a more central position before the one of the respective logs enters the centering system 100. This off-center detection system or off-center adjustment system prevents and avoids the respective logs from being overly off-center when entering the centering system 100, which prevents or reduces the likelihood of the respective logs damaging one of the plurality of rollers 112 when entering the centering system 100. Avoiding or preventing this overly off-centering of the respective log in advance of entering the centering system 100 reduces the likelihood of damage to the centering system 100, which reduces maintenance costs. Avoiding or preventing this overly off-centering of the respective log in advance of entering the centering system 100 reduces the likelihood of damage to the respective logs, which increases yield.

In some embodiments, the plurality of rollers 112 may be opened slightly wider than the diameter of the respective log to allow the respective log to pass through the centering system 100, based on the diameter scanned by the log scanning system 200. Once the respective log enters between the plurality of rollers 112, the plurality of rollers 112 are moved inward towards the respective log such that the plurality of rollers 112 come into contact with an outer surface of the respective log. Opening the plurality of rollers 112 slightly larger than the diameter of the respective log avoids or prevents overly off-centering of the respective log in advance of entering the centering system 100 and reduces the likelihood of damage to the centering system 100, which reduces maintenance costs. Opening the plurality of rollers 112 slightly larger than the diameter of the respective log before the respective log enters the centering system 100 reduces the likelihood of damage to the respective logs, which increases yield.

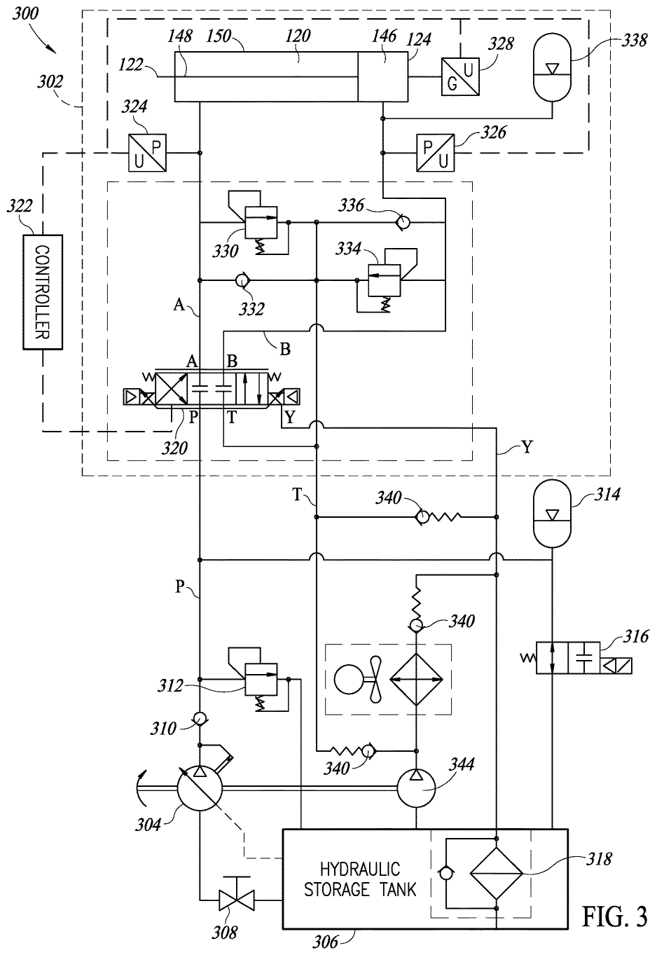

FIG. 3 is a hydraulic schematic of an embodiment of a hydraulic circuit 300 of the centering system 100. The hydraulic circuit 300 includes a closed loop control circuit 302. The hydraulic circuit 300 includes a pump line P along which a main pump 304 is present. In some embodiments, the main pump 304 may be a variable piston pump that maintains a constant pressure. The main pump 304 is in fluid communication with the hydraulic fluid storage tank 306 along the pump line P. A hydraulic fluid (e.g., hydraulic oil or some other similar or like type of hydraulic fluid) may be pumped by the main pump 304 through the hydraulic circuit 300 as shown in FIG. 3 and through the pump line P. A main pump valve 308 along the pump line P may be present between the main pump 304 and the storage tank 306. When the main pump valve 308 is open, the main pump 304 may pump hydraulic fluid from the storage tank 306 into the hydraulic circuit 300 and into the pump line P. When the main pump valve 308 is closed, the main pump 304 may not have access to the hydraulic fluid present within the storage tank 306 as the main pump valve 308 in the closed position blocks or prevents hydraulic fluid from reaching the main pump 304 along the pump line P.

A main pump check valve 310 along the pump line P is downstream from the main pump 304. The main pump check valve 310 is configured to, in operation, prevent backflow from respective areas of the hydraulic circuit 300 downstream from the main pump 304.

A main pump system relief valve 312, which may be referred to as a pressure relief valve or pressure relieving valve, that is in fluid communication with the pump line P is downstream from the main pump check valve 310. The main pump system relief valve 312 is present to prevent or avoid a buildup of excess pressure to avoid catastrophic failure or cavitation (i.e., air bubbles that may cause a vacuum within the hydraulic circuit 300) within the hydraulic circuit 300.

A first accumulator 314 is downstream from the main pump check valve 310. The first accumulator 314 is at least partially filled with a pressurized fluid (e.g., nitrogen gas) at a constant pressure and at least partially filled with the hydraulic fluid present within the hydraulic circuit 300. For example, if there is a slight increase or decrease of the pressure within the hydraulic circuit 300, the presence of the first accumulator 314 provides near-instantaneous mitigation of this slight increase or decrease in the pressure within the hydraulic circuit 300 to maintain a selected constant pressure within the hydraulic circuit 300 For example, when there is an increase or decrease, which may only be slight, in the pressure, the first accumulator 314, which is at least partially filled with the pressurized fluid at the constant pressure and at least partially filled with the hydraulic fluid, may release or receive some of the hydraulic fluid into or from the hydraulic circuit 300 immediately allowing for the pressure within the hydraulic circuit 300 to remain at the selected constant pressure. In other words, the volume of the pressurized fluid (e.g., nitrogen gas) within the first accumulator 314 may change due to the slight increase or decrease in pressure within the hydraulic circuit 300 and may act as an equalization pressure. This change in volume of the pressurized gas within the first accumulator 314 allows for the slight increase or decrease in pressure within the hydraulic circuit 300 to be nearly instantaneously mitigated to maintain the selected constant pressure due to the presence of the pressurized fluid within the first accumulator 314.

The first accumulator 314 assists in maintaining the constant pressure within the hydraulic circuit 300 as if the first accumulator 314 were not present there may be a slight delay in the main pump 304 being capable of mitigating the slight increase or decrease in the pressure within the hydraulic circuit 300 to maintain the constant selected pressure within the hydraulic circuit 300 due to a period of time to actuate or move a swash plate within the main pump 304. Actuation of the swash plate within the main pump 304 is performed to maintain the selected constant pressure within the hydraulic circuit 300. In some embodiments, the swash plate may be actuated to introduce additional hydraulic fluid from the storage tank 306 into the hydraulic circuit 300 (e.g., increase pressure within the hydraulic circuit 300). In some embodiments, the pressure relief valve 312 will vent excess oil back in the storage tank 306.

After the slight increase or decrease of the pressure within the hydraulic circuit 300 is mitigated by the first accumulator 314 such that the pressure within the hydraulic circuit 300 remains at the selected constant pressure, the first accumulator 314 may be at least partially filled with the hydraulic fluid and at least be partially filled with the pressurized fluid in an equilibrium state. Once at the equilibrium state again, in view of another successive change in pressure (i.e., successive slight increase or decrease) within the hydraulic circuit 300, the same or similar process may be performed utilizing the first accumulator 314 to maintain the selected constant pressure within the hydraulic circuit 300 by responding nearly instantaneously even in view of the slight delay in the main pump 304 to maintain the selected constant pressure within the hydraulic circuit 300.

A de-energization valve 316 is downstream of the first accumulator 314 and is upstream of the hydraulic storage tank 306. The de-energization valve 316 is configured to, in operation, de-energize the hydraulic circuit 300 by releasing pressure from the hydraulic circuit when the centering system 100 is not being utilized (e.g., is turned off and not being utilized to process and debark respective logs).

A return filter 318 may be present within the hydraulic storage tank 306. The return filter is configured to, in operation, filter the hydraulic fluid previously present within the hydraulic circuit 300 before being stored within the storage tank 306 for re-utilization within the hydraulic circuit 300 at a later time. In other words, any of the hydraulic fluid previously present within the hydraulic circuit 300 to be stored within the storage tank 306 passes through the return filter 318 before being reintroduced into the storage tank 306.

A proportional direction control valve 320 of the closed loop control circuit or system 302 is in fluid communication with the main pump line P and is downstream of the main pump check valve 310. The proportional direction control valve 320 is in fluid communication with a first hydraulic line A, a second hydraulic line B, and a drain line Y. The proportional direction control valve 320 is in electrical communication with a controller 322, which is configured to, in operation, control the proportional direction control valve 320 by sending control signals to the proportional direction control valve 320 to open and close the proportional direction control valve 320.

In a first operational state as controlled by the controller 322, the proportional direction control valve 320 allows for the hydraulic fluid to enter the first hydraulic line A such that the first hydraulic line A is an inlet line for the closed loop control circuit 302 and to exit the second hydraulic line B such that the second hydraulic line B is an outlet line for the closed loop control circuit 302. In the first operational state, the second hydraulic line B is in fluid communication with a tank line T, which is in fluid communication with the storage tank 306, such that the hydraulic fluid exits through the second hydraulic line B and enters the tank line T to be eventually transported back to the storage tank 306. In the first operational state, the hydraulic fluid on the first side of the piston head 146 is increased and the hydraulic fluid on the second side of the piston head 146 is decreased (e.g., the volume of hydraulic fluid on the first side is increased and the volume of the hydraulic fluid on the second side is decreased) resulting in retraction of a piston rod 148 into a casing 150 of the hydraulic piston 120. This retraction of the piston rod 148 into the casing 150 of the hydraulic piston 120 results in the plurality of rollers 112 rotating and translating outward and away from the center of the opening 110.

In a second operational state as controlled by the controller 322, the proportional direction control valve 320 allows for the hydraulic fluid to enter the second hydraulic line B such that the second hydraulic line B is an inlet line for the closed loop control circuit 302 and to exit the first hydraulic line A such that the first hydraulic line A is an outlet line for the closed loop control circuit 302. In the second operation state, the first hydraulic line A is in fluid communication with the tank line T such that the hydraulic fluid exits through the first hydraulic line A and enters the tank line T to be eventually transported back to the storage tank 306. In the second operational state, the hydraulic fluid on the second side of the piston head 146 is increased and the hydraulic fluid on the first side of the piston head 146 is decreased (e.g., the volume of hydraulic fluid on the second side is increased and the volume of the hydraulic fluid on the first side is decreased) resulting in extension of the piston rod 148 out of the casing 150 of the hydraulic piston 120. This extension or protrusion of the piston rod 148 out of the casing 150 of the hydraulic piston 120 results in the plurality of rollers 112 rotating and translating inward and towards the center of the opening 110.

In at least one alternative embodiment, the hydraulic piston 120 may be replaced with another type of actuator. For example, in at least one alternative embodiment, the hydraulic piston 120 may be replaced with a rotary actuator or angular actuator that may rotate the plurality of arms 114 to position the plurality of rollers 112. In other words, while a hydraulic piston 120 may be utilized in the embodiment as shown in FIGS. 1A-1F, other types of actuators may be utilized to actuate the plurality of rollers 112 and pre-position or position the plurality of rollers 112 as discussed herein.

In at least one alternative, the hydraulic piston 120 may be replaced by another type of actuator. For example, in at least one alternative embodiment, the hydraulic piston 120 may be replaced with one or more linear actuators to actuate or slide the plurality of rollers between an opened position and a closed position. In at least one alternative embodiment, there may be a one-to-one relationship between the plurality of rollers 112 and one or more linear actuators. For example, when there are three rollers in the plurality of rollers 112, there may be three linear actuators, and each linear actuator of the three linear actuators linearly moves or slides the corresponding roller of the three rollers along a corresponding linear pathway to contact the three rollers with an outer surface of a respective log.

In some alternative embodiments of the centering system 100, the first operational state of the closed loop control circuit 302 may result in the plurality of rollers 112 rotating inwards and towards the center of the opening 110, and the second operational state of the closed loop control circuit 302 may result in the plurality of rollers 112 rotating outwards and away from the center of the opening 110. In other words, the retraction of the piston rod 148 into the casing 150 of the hydraulic piston 120 may be adapted to either result in the retraction corresponding to rotating the plurality of rollers 112 inwards or outwards and the extension of the piston rod 148 out of the casing 150 resulting in the opposite movement of the plurality of rollers 112 depending on whether the retraction of the piston rod 148 results in either inwards or outwards movement of the plurality of rollers 112.

In at least one alternative embodiment of the centering system 100 in which the centering system includes a rotary actuator instead of the hydraulic piston 120, the rotary actuator may be controlled and actuated to move the plurality of rollers 112 inwards and towards the center of the opening 110, and, oppositely, the rotary actuator may be controlled and actuated to move the plurality of rollers 112 outwards and away from the center of the opening 110.

The first hydraulic line A is in fluid communication with a first side of a piston head 146 of the hydraulic piston 120 and the second hydraulic line B is in fluid communication with a second side of the piston head 146 opposite to the first side of the piston head 146. The second side of the piston head 146 is opposite to the first side of the piston head 146. A piston rod 148 is coupled to the piston head 146 and may include the first end 122 of the hydraulic piston 120, which is in mechanical cooperation with the first portion 134 of the mechanical linkage 126.

The controller 322 may increase or decrease pressure within the closed loop control circuit 302 by partially opening and closing the proportional direction control valve 320. In other words, the pressure within the closed loop control circuit 302 may be controlled by the controller controlling the opening and closing of the proportional direction control valve 320.

The controller 322 may switch the proportional direction control valve 320 between the first operational state and the second operational state to translate the hydraulic piston 120 of the centering system 100 to rotate the plurality of rollers 112 either inward or outward as represented by the arrows 118a, 118b.

A first pressure sensor or transducer 324 is at a location along the first hydraulic line A. The first pressure transducer 324 is configured to, in operation, monitor and detect a first pressure within the first hydraulic line A. The first pressure transducer 324 is in electrical communication with the controller 322, and the first pressure transducer 324 may output at least one first electrical signal to the controller 322 which the controller 322 may process to determine the first pressure within the first hydraulic line A.

A second pressure sensor or transducer 326 is at a location along the second hydraulic line B. The second pressure transducer 326 is configured to, in operation, monitor and detect a second pressure within the second hydraulic line B. The second pressure transducer 326 is in electrical communication with the controller 322, and the second pressure transducer 326 may output at least one second electrical signal to the controller 322 which the controller 322 may process to determine the second pressure within the second hydraulic line B.

A positional sensor or transducer 328 monitors a position (e.g., retraction or extension of the piston rod 148) of the hydraulic piston 120. For example, the positional transducer 328 monitors a respective position of the piston head 146 and piston rod 148 as the piston head 146 is coupled to the piston rod 148. The positional transducer 328 is in electrical communication with the controller 322, and the positional transducer 328 may output at least one positional electrical signal to the controller 322 which the controller 322 may process to determine a position of the hydraulic piston 120.

In some alternative embodiments, the positional sensor or transducer 328 may be utilized along with other types of sensors or transducers for monitoring various qualities or characteristics of the components in real time. For example, these other types of sensors or transducers may be angular transducers, speed transducers, rotational speed transducers or some other types of sensors or transducers.

A first direct acting relief valve 330 and a first check valve 332 are in fluid communication with the first hydraulic line A, and a second direct acting relief valve 334 and second check valve 336 are in fluid communication with the second hydraulic line B. The first and second direct acting relief valves 330, 334, respectively, and the first and second check valves 332, 336, respectively, are in fluid communication with the tank line T. The first and second direct acting relief valves 330, 334, respectively, and the first and second check valves 332, 336, respectively, are present to act as safety measures to allow for excess pressure to be dissipated through the tank line T from the closed loop control circuit 302 to avoid catastrophic failure within the closed loop control circuit 302 in the event of excess pressure buildup within the closed loop control circuit 302.

A second accumulator 338 is provided along the second hydraulic line B. The second accumulator is pre-charged with a pressurized fluid (e.g., nitrogen gas or fluid) at a pressure greater than a pressure within the closed loop control circuit 302 of the hydraulic circuit 300. If a crash of the system occurs or begins to occur, the increase in pressure within the closed loop system 302 results in at least some of the hydraulic fluid present within the closed loop hydraulic circuit 302 entering the second accumulator 338 nearly instantaneously mitigating the increase in pressure and preventing the hydraulic circuit 300 from crashing. In other words, the second accumulator 338 acts as a safety feature in combination with the first and second direct acting relief valves 330, 334, respectively, and the first and second check valves, 332, 336, respectively. In other words, when some combination of the first and second direct acting relief valves 330, 334, respectively, and the first and second check valves 332, 336 are opened and closed to prevent catastrophic failure, the second accumulator 338 may provide near instantaneous mitigation of an increase in the pressure within the first and second hydraulic lines A, B, respectively, to prevent and mitigate catastrophic failure within at least the closed loop circuit 302 of the hydraulic circuit 300. The second accumulator 338 allowing for the instantaneous reaction to mitigate, for example, an increase in pressure within the closed loop circuit 302 prevents catastrophic failure as a maximum pressure within the closed loop circuit 302 may not exceed or be equal to a selected maximum pressure.

In at least one embodiment in which the extending of the hydraulic piston 120 caused the plurality of rollers 112 to open and the retracting of the hydraulic piston 120 caused the plurality of rollers 112 to close, the second accumulator 338 may be in fluid communication with the first hydraulic line A instead of hydraulic line B. Along with the second accumulator 338, the controller 322 may utilize the information collected by the first pressure transducer 324, the second pressure transducer 326, and the positional transducer 328 to determine whether the plurality of rollers 112 is in appropriate physical contact with the external surface 132 of the log 130 as the log 130 passes through the centering system 100 to maintain an appropriate force on the external surface 132 of the log 130 such that the log is appropriately centered when entering and passing through the debarker. As discussed earlier herein, the controller 322 may switch the proportional direction control valve 320 between the first operational state and the second operational state multiple times as the log 130 passes through the centering system 100 to maintain the target pressure or pressures within the first and second hydraulic lines A, B, respectively, to maintain a constant force on the external surface 132 of the log 130. By switching the proportional direction control valve 320 between the first and second operational states as the log 130 passes through the centering system 100, the target pressure or pressures is maintained and the forces applied to the external surface 132 of the log 130 remain constant even in view of fluctuations in the diameter D1 of the log 130 as the log 130 passes through the centering system 100 such that the log 130 remains centered along its entire length when entering the debarker regardless of these fluctuations in the diameter D1 of the log 130.

The drain line Y is configured to, in operation, drain any excess or leftover of the hydraulic fluid present within the proportional direction control valve 320. The drain line Y allows for the proportional direction control valve 320 to be as reactive as possible as trying to utilize the tank line T, which is pressurized, to drain the excess or leftover of the hydraulic fluid would be slower than providing and utilizing the drain line Y. The tank line T is pressurized to avoid cavitation (i.e., generation of air bubbles within the closed loop control circuit 302 of the hydraulic circuit 300 or within the overall hydraulic circuit 300). For example, if the tank line T were not pressurized and utilized to drain the proportional direction control valve 320, abrupt fluctuations in the diameter D1 of the log 130 as the log 130 passes through the centering system 100 may result in the plurality of rollers 112 moving inward or outward quickly resulting in cavitation within either one of the first and second hydraulic lines A, B, respectively. By pressurizing the tank line T and providing the drain line Y, this issue with cavitation within the first and second hydraulic lines A, B, respectively, may be mitigated, prevented, or reduced in likelihood of occurring.

A plurality of check valves 340 is present such that the tank line T may be pressurized as discussed above. For example, the plurality of check valves 340 may be configured to, in operation, be opened and closed to pressurize the tank line T. In some embodiments, the tank line T may be pressurized with a pressure being substantially equal to 50 pounds per square inch (psi). In some situations, if a vacuum begins to occur within the tank line T, the check valves 340 may be opened to prevent the vacuum from occurring by allowing hydraulic fluid to pass between the drain line Y, the tank line T, and the hydraulic fluid that passes through a hydraulic cooler 342. Preventing the occurrence of this vacuum prevents cavitation within the hydraulic circuit 300.

The hydraulic cooler 342 is present and is in fluid communication with a pilot/charge pump 344 and is in fluid communication with at least one of the check valves 340, which is between the hydraulic cooler 342 and the drain line Y. The hydraulic cooler 342 is configured to, in operation, cool down the hydraulic fluid that passes through the hydraulic cooler 342 to maintain a stable temperature within the hydraulic circuit 300 to avoid overheating within the hydraulic circuit 300. Maintaining the hydraulic circuit 300 below or equal to a threshold temperature prevents or reduces the likelihood of cavitation from occurring within the hydraulic circuit 300. The pilot/charge pump 344 may be utilized to pressurize the tank line T.

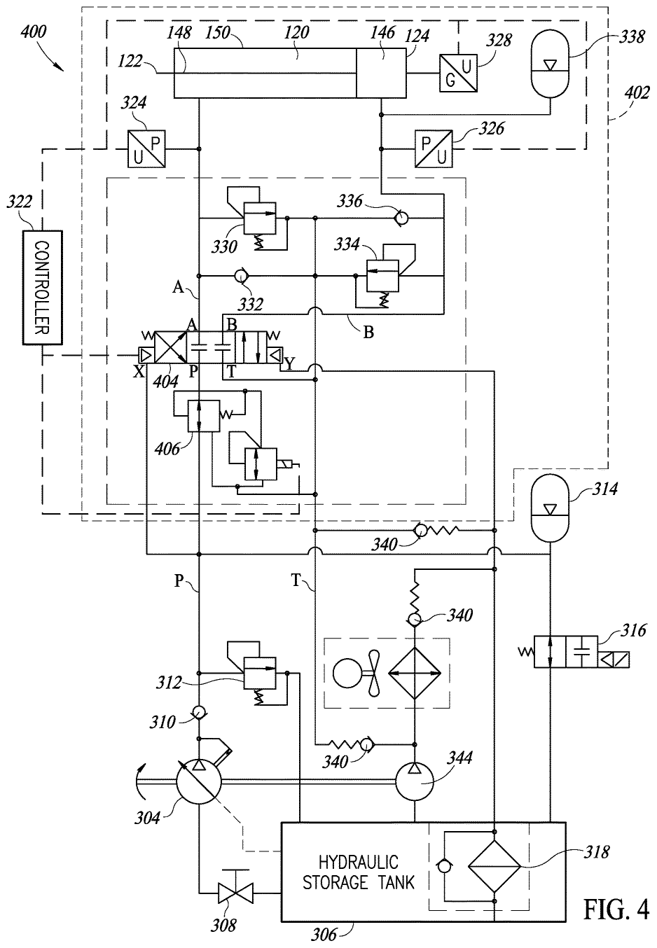

FIG. 4 is a schematic of an alternative embodiment of a hydraulic circuit 400 with a closed loop control circuit or system 402. The closed loop control circuit 402 has several of the same or similar features of the closed loop control circuit 302. Accordingly, the following discussion with respect to the closed loop control circuit 402 of the hydraulic circuit 400 will focus on different or additional features between the control loop control circuit 402 relative to the control loop control circuit 302.

The proportional direction control valve 320 in the closed loop control circuit 302 has been replaced by a direction control valve 404 and an electro-proportional relief valve 406. The combination of the direction control valve 404 and the electro-proportional relief valve 406 in the closed loop control circuit 402 function in the same or similar manner as the proportional direction control valve 320 in the closed loop control circuit 302. However, while the proportional direction control valve 320 may be proportionally or partially open or closed to control amounts of the hydraulic fluid introduced or exiting the first and second hydraulic lines A, B, respectively, to control pressures within the first and second hydraulic lines A, B, respectively, the direction control valve 404 may only be fully opened or fully closed to either allow hydraulic fluid to enter or exit the first and second hydraulic lines A, B, respectively. This fully opening or closing of the direction control valve 404 results in the direction control valve 404 only controlling the direction in which the hydraulic fluid passes through the first and second hydraulic lines A, B, respectively, and the direction control valve 404 not controlling the amount of the hydraulic fluid that enters or exits the first and second hydraulic lines A, B, respectively. Instead, the electro-proportional relief valve 406 is controlled (e.g., opened and closed) such as to control the amount of hydraulic fluid that exits or enters the first and second hydraulic lines A, B, respectively, to maintain a selected or setpoint pressure. In other words, the direction control valve 404 controls the direction of flow of the hydraulic fluid through the first and second hydraulic lines A, B, respectively, while the electro-proportional relief valve 406 controls the amount of the hydraulic fluid that is passing into and out of the first and second hydraulic lines A, B, respectively. This combination of the direction control valve 404 and the electro-proportional relief valve 406 allows for the pressure within the first and second hydraulic lines A, B, respectively, to be controlled in the same or similar fashion as the proportional direction control valve 320. However, the combination of the direction control valve 404 and the electro-proportional relief valve 406 may be slightly slower in adjusting the pressures within the first and second hydraulic lines A, B, respectively, when compared to controlling the pressures within the first and second hydraulic lines A, B, respectively, with the proportional direction control valve 320.

In view of the discussion within the present disclosure with respect to FIGS. 3 and 4, the first and second accumulators 314, 338 are configured to, in operation, perform or act as hydraulic springs to avoid catastrophic failure within the hydraulic circuits or systems 300, 400, respectively. While the first and second accumulators 314, 338 are present within the embodiments of the hydraulic circuits or systems 300, 400, respectively, in some other embodiments, one or both of the first and second accumulators 314, 338 may be replaced with another type of spring like structure or feature. For example, one of or both of the first and second accumulators 314, 338 may be replaced with a mechanical spring or some other similar or like type of spring structure that allows for mitigation of pressure build up within the hydraulic circuits 300, 400, respectively.

The hydraulic circuit 400 further includes a third hydraulic line X that extends to the pump line P. In at least some embodiments, the third hydraulic line X is in fluid communication with the pump line P.

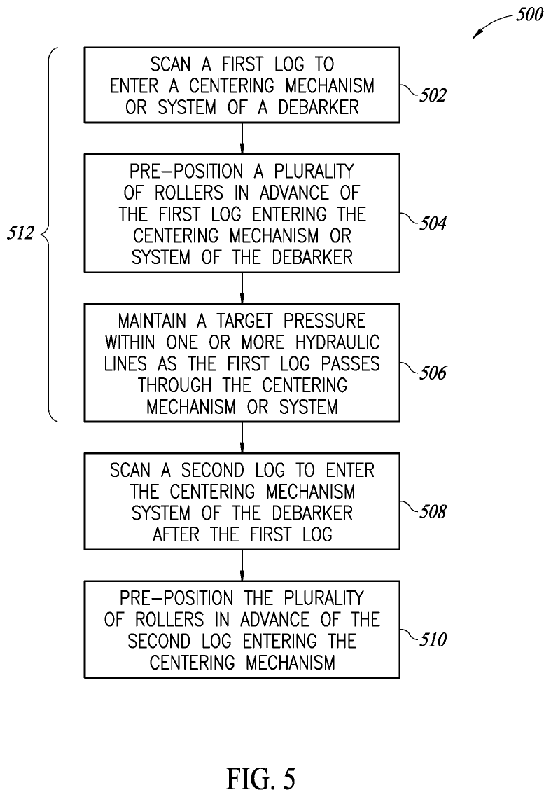

FIG. 5 is a flowchart 500 of an embodiment of a method of controlling the plurality of rollers 112 of the embodiment of the centering system 100 as shown in FIGS. 1A-1F of the present disclosure including at least one of the respective embodiments of the hydraulic circuits 300, 400 including at least one of the closed loop control circuits or systems 302, 402 as shown in FIGS. 3 and 4 of the present disclosure. The flowchart 500 includes a first step 502, a second step 504, a third step 506, a fourth step 508, and a fifth step 510. While the following discussion will focus on utilizing the closed loop control circuit 302 as shown in FIG. 3 to control the plurality of rollers 112 of the centering mechanism or system 100, it will be readily apparent that the above method may be carried out utilizing the closed loop control circuit 402 as shown in FIG. 4 as well.

In the first step 502, the log scanning system 200 scans a first log in advance of the first log entering the centering system 100 and passing through and between the plurality of rollers 112. As discussed earlier herein, the log scanning system 200 scans the first log to determine the diameter of the first log (e.g., a diameter at a first end of the first log to initially enter the centering system 100). For example, the log scanning system 200 may send an electrical signal representative of the diameter of the first log to the controller 322 such that the controller 322 may utilize this electrical signal to determine the diameter of the first log. The controller 322 may collect or have already collected an electrical signal from the positional transducer 328 such that the controller 322 will or already has determined the current position of the plurality of rollers 112. The controller 322 may utilize the determined diameter of the first log and the current position of the plurality of rollers 112 to determine whether the plurality of rollers 112 needs to be moved to pre-position the plurality of rollers 112 to a pre-position or an initial position before the first log begins to enter the centering system 100. If the controller 322 determines that the plurality of rollers 112 is positioned such that the likelihood of damage to the plurality of rollers 112 is high or is not positioned appropriately to center the first log within the debarker, in the second step 504, the controller 322 sends a control signal to the proportional direction control valve 320 to actuate the hydraulic piston 120 to pre-position the plurality of rollers 112 in advance of the first log entering the centering system 100. Once the plurality of rollers 112 is pre-positioned after the second step 504, the first log shortly thereafter enters the centering system 100 and passes through and between the plurality of rollers 112.

In the third step 506, as the first log passes through the plurality of rollers 112 of the centering system 100, one or more target pressures are maintained within the first and second hydraulic lines A, B, respectively, to maintain physical contact between the plurality of rollers 112 and an external surface of the first log such that a selected force is applied to the external surface of the first log by the plurality of rollers 112. For example, the respective pressures within the first and second hydraulic lines A, B, respectively, are monitored by the first and second pressure transducers 324, 326, respectively. The controller 322 may receive electrical signals from the first and second pressure transducers 324, 326 to maintain one or more target pressures within the first and second hydraulic lines A, B, respectively, to maintain physical contact between the plurality of rollers 112 and an external surface of the first log such that a selected force is applied to the external surface of the first log by the plurality of rollers 112. For example, if one of the respective pressures within the first and second hydraulic lines A, B, respectively, exceeds or is equal to an upper pressure threshold or is less than or equal to a lower pressure threshold, the controller 322 may increase or decrease the respective pressures to be at the one or more target pressures within the first and second hydraulic lines A, B, respectively, by adjusting the amount of the hydraulic fluid passing into and out of the first and second hydraulic lines A, B, respectively, or by adjusting the directional flow of the hydraulic fluid through the first and second hydraulic lines A, B, respectively. The controller 322 targeting the one or more target pressures within the first and second hydraulic lines A, B, respectively, results in the plurality of rollers 112 moving inward and outward as the diameter of the first log fluctuates along its length and passes through the centering system 100 such that the plurality of rollers 112 maintain physical contact with the external surface of the first log and apply a controlled force to the external surface of the first log. Maintaining and controlling contact of the plurality of rollers 112 and maintaining and controlling the force on the external surface of the first log results in the first log passing through the centering system 100 such that the first log is properly and effectively centered, resulting in the debarker efficiently removing bark from the first log.

In the fourth step 508, a second log is to successively enter the centering system 100 after the first log. In the fourth step 508, the log scanning system 200 scans the second log and the same process as discussed earlier herein with respect to the first step 502 is performed. If the controller 322 determines that the plurality of rollers 112 needs to be moved to pre-position the plurality of rollers 112 in advance of the second log entering the centering system 100, in the fifth step 510, the controller 322 sends a control signal to the proportional direction control valve 320 to pre-position the plurality of rollers 112 in the same fashion as in the second step 504 such that the second log is properly centered when entering the debarker by the centering system 100.

The first, second, and third steps 502, 504, 506 may be a group of steps 512 that may be performed over and over again in succession to center multiple respective logs that pass through the centering system 100 into the debarker to debark the multiple respective logs. In other words, the group of steps 502, 504, 506 are performed for each one of the multiple respective logs to pass through the centering system 100 of the debarker such that each one of the multiple respective logs is centered while entering the debarker improving efficiency of the debarker while preventing or reducing the likelihood of damage to components within the debarker as each one of the multiple respective logs enters and passes through the debarker.

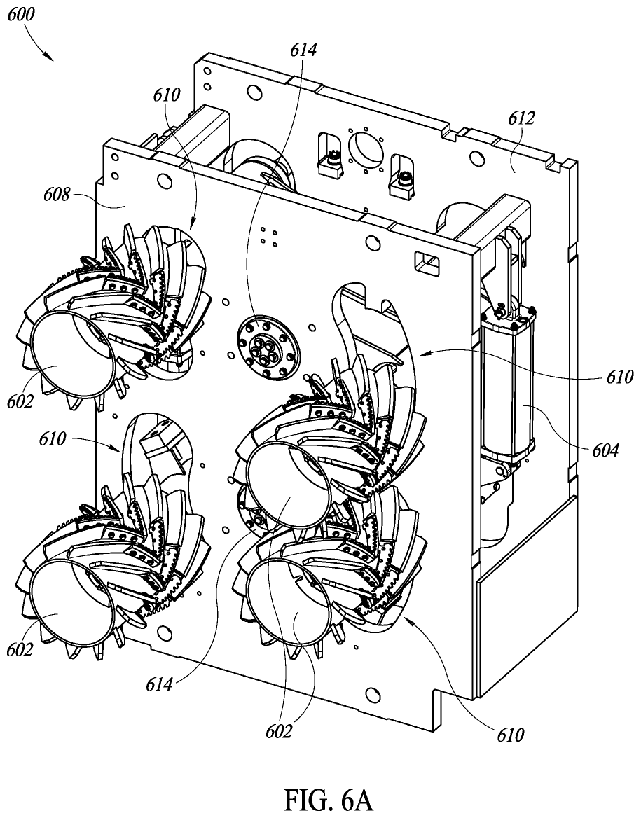

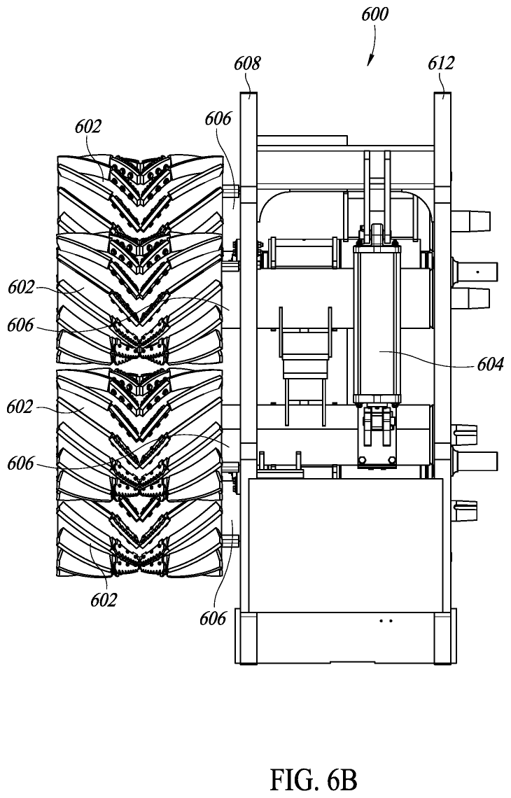

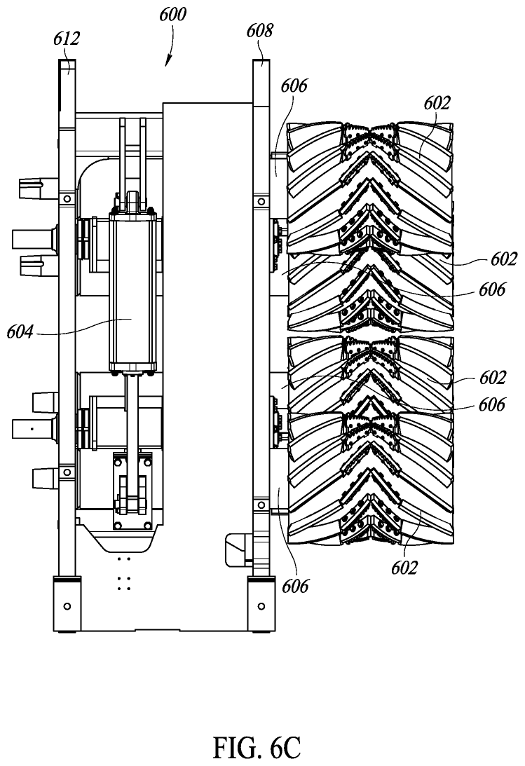

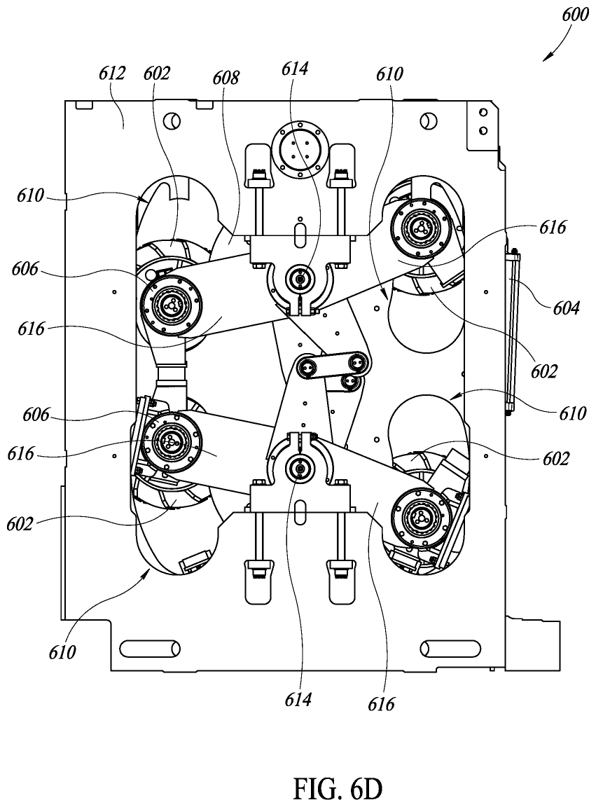

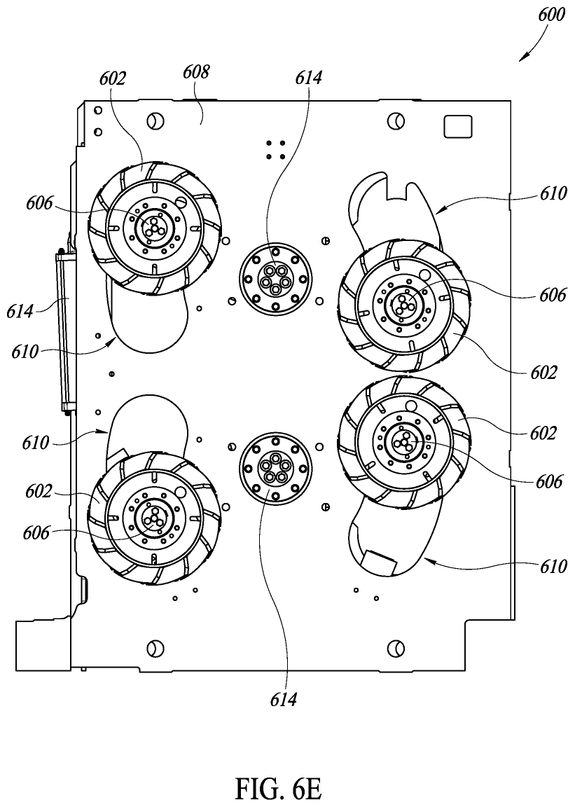

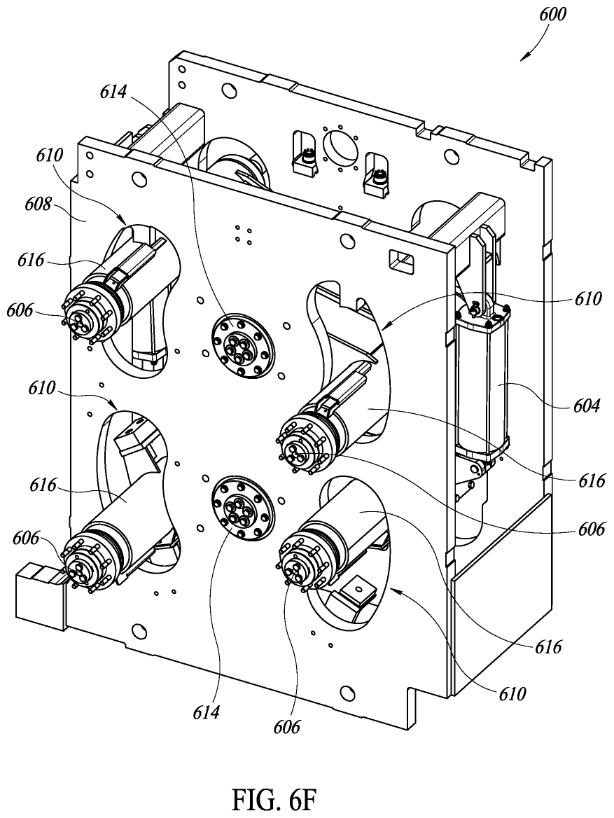

FIG. 6A is a perspective view of an embodiment of a driving mechanism or system 600 including one or more feedrolls 602 that are driven by one or more motors to pull respective logs through the debarker. FIG. 6B is a right side view of the driving mechanism or system 600. FIG. 6C is a left side view of the driving mechanism or system 600. FIG. 6D is a rear side view of the driving mechanism or system 600. FIG. 6E is a front side view of the driving mechanism or system 600. FIG. 6F is a perspective view of the driving mechanism or system 600 with the one or more feedrolls 602 removed such that respective components of the driving mechanism or system 600 are more readily visible.

In some situations, the driving mechanism or system 600 may be positioned between the centering mechanism or system 100 and a rotary cutter mechanism or system of the debarker such that the respective log initially passes through the centering mechanism, then passes through the driving mechanism or system 600, and then passes into the rotary cutter mechanism or system to debark the respective log. In some situations, the driving mechanism or system 600 may be positioned in advance of the centering mechanism or system 100.

In some situations, other various timber processing components, mechanisms, or systems may be in line with the centering mechanism or system 100, the driving mechanism or system 600, or both. For example, these other various timber processing components, mechanisms, or systems may include rotary cutter mechanisms or systems, variable flare reducer mechanisms or systems, or some other suitable or like type of timber processing components, mechanisms, or systems that may be utilized within a respective debarked to process logs.

One or more hydraulic pistons or cylinders 604 are present that work in mechanical cooperation with various components of the driving mechanism or system 600 to translate (e.g., move upwards and downwards based on the orientation as shown in FIG. 6F) one or more shafts 606 (see at least FIG. 6E) to which the one or more feedrolls 602 are mounted. The one or more shafts 606 may be rotated by the one or more motors to rotate the one or more feedrolls 602 mounted to the one or more shafts 606 to drive respective logs between the one or more feedrolls 602 through a debarker.

A first frame 608 of the driving mechanism or system 600 includes one or more pathway slots 610 that extend through the first frame 608. The one or more shafts 606 extend through the one or more pathway slots 610 in the first frame 608. For example, each one of the one or more shafts 606 extends through a corresponding pathway slot of the one or more pathway slots 610. The one or more pathway slots 610 may be configured to, in operation, provide clearance for the one or more shafts 606 to be translated upwards and downwards. The one or more pathway slots 610 may be positioned and structured such that the one or more feedrolls 602 may not contact each other when at lower and upper ends of the one or more pathway slots 610. For example, see the feedrolls 602 on the right-hand side of FIG. 6E in which the lower feedroll 602 is at the upper end of the lower pathway slot 610 and the upper feedroll 602 is at the lower end of the upper pathway slot 610 at the right-hand side of the driving mechanism. For example, see the feedrolls 602 on the left-hand side of FIG. 6E in which the lower feedroll 602 is at the lower end of the lower pathway slot 610 and the upper feedroll 602 is at the upper end of the upper pathway slot 610 at the left-hand side of FIG. 6E.

While the one or more pathway slots 610 are shown as having a curved profile (e.g., being curved), in some alternative embodiments, the one or more pathway slots 610 may be relatively linear or straight such that the pathway slots 610 are not curved. In some embodiments, the drive mechanism or system 618 may include a linear actuator that linearly actuates the feedrolls 602 of the drive mechanisms or system 600 upwards or downwards along the pathway slots 610. In some alternative embodiments, the drive mechanism or system 618 may include a rotary actuator that may be utilized to move the feedrolls 602 upwards and downwards and along the pathway slots 610 as shown in FIGS. 6A-6F.

A second frame 612 of the driving mechanism or system 600 is opposite to the first frame 608. The second frame 612 may be a support frame that provides additional support to the various components of the driving mechanism or system 600. In some embodiments, the first frame 608 and the second frame 612 may be fastened together, and, in some alternative embodiments, the first frame 608 and the second frame 612 may be integral with each other.

One or more pivots 614 are present about which one or more arms 616 pivot, respectively. For example, when the one or more hydraulic pistons 604 (e.g., one at the left hand side of the first and second frames 608, 612 and one at the right hand side of the first and second frames 608, 612) are retracted and extended, the one or more arms 616 rotate about the one or more pivots 614 moving the one or more shafts 606 in an upwards or downwards direction along the one or more pathway slots 610. This translation of the one or more shafts 606 in the upwards and downwards direction based on the orientation of the driving mechanism or system 600 moves the one or more feedrolls 602 in the upwards and downwards direction as well. For example, as a respective log is being driven through the driving mechanism or system 600, the pair of feedrolls 602 at the right-hand side of the driving mechanism or system 600 clamp down onto the respective log and are driven by one or more motors to drive the respective log through the driving mechanism or system 600. Similarly, as the respective log is being driven through the driving mechanism or system 600, the pair of feedrolls 602 at the left-hand side of the driving mechanism or system 600 clamp down onto the respective log and are driven by one or more motors (e.g., hydraulic motors, electric motors, servo motors, gas motors, diesel motors, or some other suitable type of motor) to drive the respective log through the driving mechanism or system 600. While not shown herein, the one or more hydraulic pistons 604 may be controlled utilizing either of the hydraulic circuits 300, 400 depending on which one of the hydraulic circuits 300, 400 is utilized to control the one or more hydraulic pistons 604, respectively. In other words, the hydraulic pistons 604 may be controlled utilizing the same control circuits 300, 400 as discussed in detail earlier herein with respect to controlling the plurality of rollers 112. Accordingly, for simplicity and brevity of the present disclosure, those details are not reproduced herein.

As shown in FIG. 6F, each one of the one or more arms 616 may include a sleeve-like structure that extends around one of the corresponding ones of the one or more shafts 606. The sleeve like structures may be utilized to move the one or more shafts 606 to position the one or more feedrolls 602.

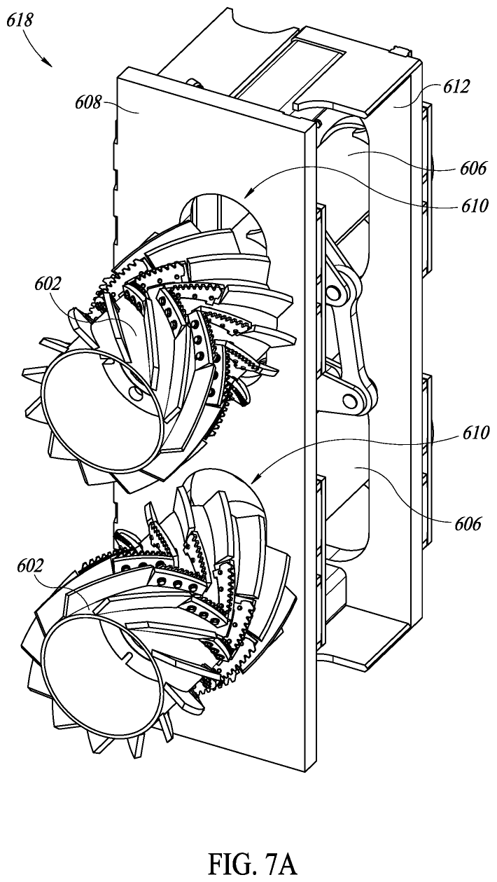

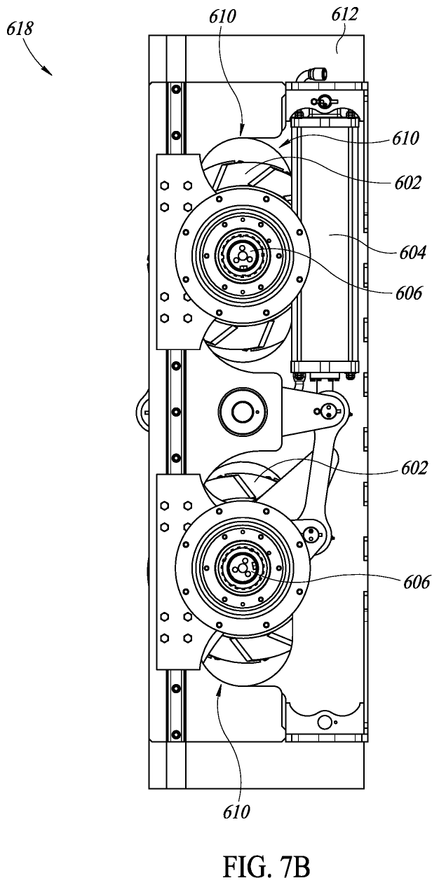

FIG. 7A is a perspective view of an alternative embodiment of a driving mechanism or system 618 that includes two of the feedrolls 602 instead of four feedrolls 602 as in the embodiment of the driving mechanism or system 600 as shown in FIGS. 6A-6F of the present disclosure. FIG. 7B is a rear side view of the alternative embodiment of the driving mechanism or system 618.

In some situations, multiple ones of the driving mechanism or system 618 may be utilized in combination with each other to drive respective logs through the debarker to process the logs into timber or other wood products. For example, the driving mechanism or system 618 may be one module that may be utilized with other modules of the driving mechanism or system 618 to drive the respective logs through the debarker.

The driving mechanism or system 618 includes several of the same or similar features of the embodiment of the driving mechanism or system 600. These same or similar reference numerals have been utilized for these same or similar features between the embodiment of the driving mechanism or system 600 and the alternative embodiment of the driving mechanism or system 618, respectively. Accordingly, for the sake of simplicity and brevity of the present disclosure, the focus of the following discussion will be on the different or additional features as shown in FIGS. 7A and 7B relative to the features as shown in FIGS. 6A-6F.

Unlike the pathway slots 610 as shown in the embodiment of the driving mechanism or system 600, the pathway slots 610 of the drive mechanism or system 618 may be more linear or straight than the curved pathway slots 610 as shown in the drive mechanism or system 600. In some embodiments, the drive mechanism or system 618 may include a linear actuator that linearly actuates the feedrolls 602 of the drive mechanisms or system 618 upwards or downwards. In some alternative embodiments, the drive mechanism or system 618 may include a rotary actuator that may be utilized to move the feedrolls 602 upwards and downwards and along the pathway slots 610 as shown in FIGS. 7A and 7B.

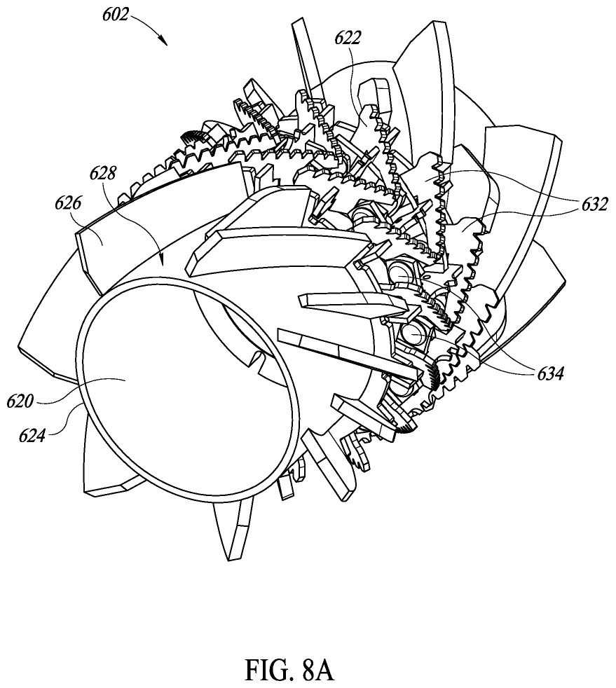

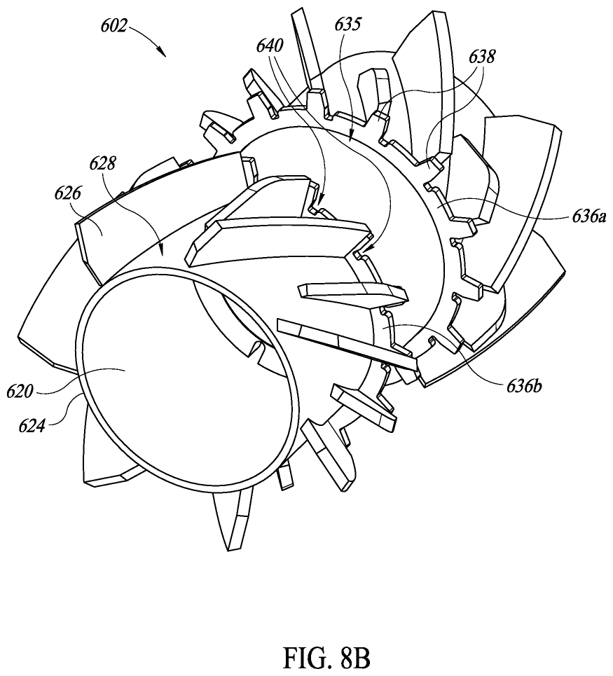

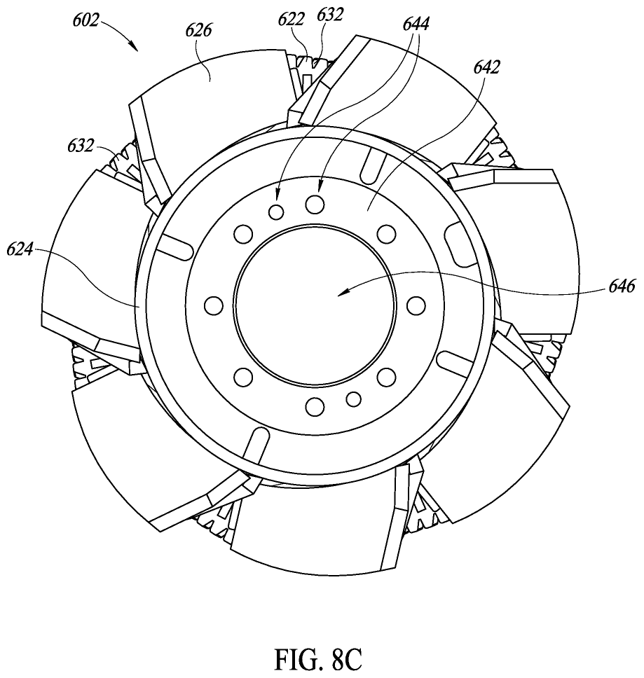

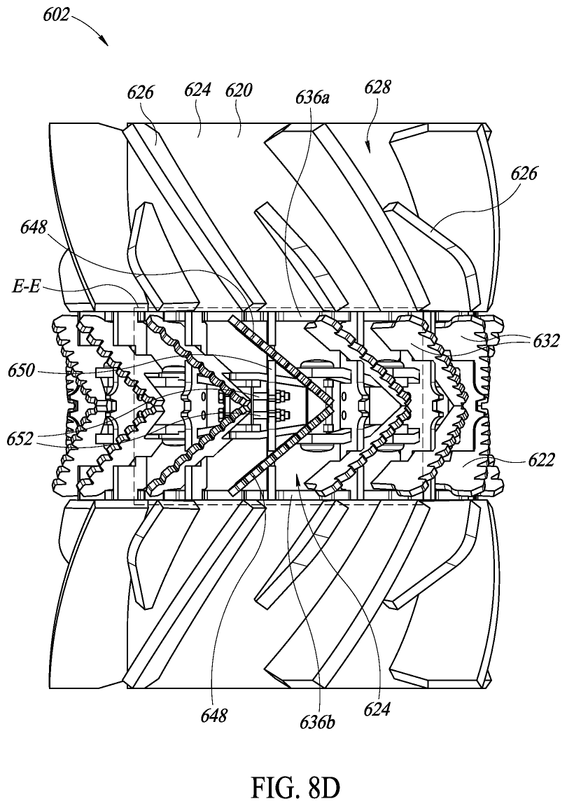

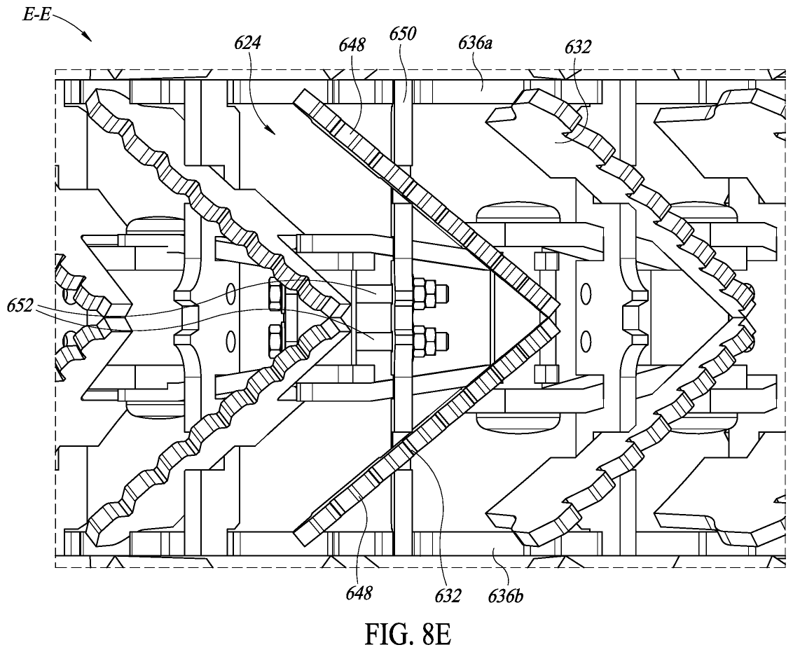

FIG. 8A is a perspective view of an embodiment of one of the one or more feedrolls 602. In this embodiment of the feedroll 602, the feedroll 602 includes a barrel 620 and a chain insert 622. The chain insert 622 is removably mounted to the barrel 620 such that the chain insert 622 may be removed to be repaired or replaced during maintenance of at least one of the driving mechanisms or systems 600, 618, respectively, of the present disclosure. For example, if one of the chain inserts 622 is worn out or broken, a maintenance employee may remove the worn out or broken chain insert 622 from the feedroll 602 and replace it with a new chain insert 622. This replacement process of the chain insert prevents the maintenance employee from having to remove and replace the entire feedroll 602. This replacement of only the chain insert 622 when broken or at the end of its usable life span reduces maintenance costs, reduces downtime, and reduces replacement part costs, relative to removing and replacing the entire feedroll 602, as only the chain insert 622 needs to be removed and replaced when broken or worn. In other words, maintenance time is reduced because, if the entire feedroll 602 were to be removed and replaced then it may take an hour or longer to replace the entire feedroll 602, whereas only removing and replacing the chain insert 622 may be performed much more quickly.

FIG. 8B is a perspective view of the embodiment of the one or more feedrolls 602 with the chain insert 622 removed from the barrel 620 of the feedroll 602. FIG. 8C is a side view of the feedroll 602. FIG. 8D is a top plan view of the feedroll 602. FIG. 8E is a zoomed in and enhanced view of section E-E as shown in FIG. 8D.

The barrel 620 includes a barrel structure or portion 624 and a plurality of barrel flutes 626 that are integral with the barrel structure 624. The plurality of barrel flutes 626 extend across an outer surface 628 of the barrel structure 624. The plurality of barrel flutes 626 are configured to, in operation, assist in pulling or moving a respective log through the driving mechanisms or systems 600, 618 of the present disclosure. The plurality of barrel flutes 626 extend outward in a radial direction from the outer surface 628 and are angled such that the extend in a circumferential direction as well. In some embodiments, the plurality of barrel flutes 626 may be angled by a greater or lesser amounts than as shown in FIGS. 8A-8E of the present disclosure.

The chain insert 622 includes one or more chain insert portions, flutes, or flute portions 632 that are coupled together as a chain by a plurality of pins 634. In some embodiments, the plurality of pins 634 may permanently couple together the one or more chain flute portions 632 of the chain insert 622. In some alternative embodiments, the plurality of pins 634 may be removable such that individual ones of the one or more chain flute portions 632 may be replaced individually. The chain insert 622 is wrapped around the barrel 620 within a chain insert region 635 of the barrel 620 at which the plurality of barrel flutes 626 are not present. For example, the chain insert region 635 of the barrel 620 is between a first group of the plurality of barrel flutes 626 and a second group of the plurality of barrel flutes 626. The first group of the plurality of barrel flutes 626 are on a first side of the chain insert region 635 and the second group of the plurality of barrel flutes 626 are on a second side of the chain insert region 635 opposite to the first side of the chain insert region 635. In this embodiment as shown in FIGS. 8A-8E, each one of the chain flute portions 632 include teeth that are configured to, in operation, assist in pulling a respective log through the driving mechanism or system 600.

A first chain insert mount portion 636a is on a first side of the chain insert region 635 and a second chain insert mount portion 636b is on a second side of the chain insert region 635. The first and second chain insert mount portions 636a include protrusions or extensions 638 in which each chain insert portion 632 of the chain insert 622 are positioned between. The protrusions or extensions 638 act as guides to properly wrap, position, and mount the chain insert 622 on the barrel 620 and within the chain insert region 635. The first and second insert mount portions 636a, 636b include chain insert slots 640 that are adjacent and in close proximity to each one of the protrusions or extensions 638. The chain insert slots 640 are configured to receive at least a portion of the chain insert 622 or the chain insert portions 632. For example, in at least some embodiments, the chain insert portions 632 are received by the chain insert slots 640 such that each one of the chain insert portions 632 is seated within a corresponding one of the chain insert slots 640. The first and second chain insert mount portions 636a, 636b define the chain insert region 635 as the first chain insert mount portion 636a is on the first side of the chain insert region, and the second chain insert mount portion 636b is on the second side of the chain insert region 635. The first chain insert mount portion 636a is between the first group of the plurality of barrel flutes 626 and the first chain inset mount portion 636a is between the second group of the plurality of barrel flutes 626 and the second chain insert mount portion 636b.

In this embodiment of the feedroll 602 as shown in FIGS. 8A-8E, each one of the protrusions or extensions 638 is aligned with a corresponding one of the plurality of barrel flutes 626. In other words, in the embodiment of the feedroll 602 as shown in FIG. 8B, there is a one-to-one relationship between the plurality of barrel flutes 626 and the protrusions or extensions 638. In some alternative embodiments of the feedroll 602, there may be a different relationship between the plurality of barrel flutes 626 and the protrusions or extensions 638.

The barrel structure 624 is at least partially hollow such that the barrel structure 624 may be mounted to one of the one or more shafts 606. A mounting structure 642 is present within the barrel structure 624. The mounting structure 642 may include one or more fastening holes or openings 644 that are configured to receive fasteners for mounting the feedroll 602 to one of the one or more shafts 606.

An opening 646 may extend through and be defined by the mounting structure 642. The opening 646 is configured to receive one of the one or more shafts 606 when mounting the feedroll 602 on the one of the one or more shafts 606.

As shown in FIG. 8D, each one of the chain insert portions 632 of the chain insert 622 includes two angled portions 648 and a transverse portion 650 that extends across the two angled portions 648. The transverse portion 650 extends outward from the two angled portions 648. The two angled portions 648 meet such that the two angled portions 648 and the transverse portion 650 define a triangular-like shape, and the two angled portions 648 define a V-like shape. The transverse portion 650 extending outward from the two angled portions 648 is inserted into a corresponding chain insert slot 640 of the first chain insert mount portion 636a and a corresponding chain insert slot 640 of the second chain insert mount portion 636b.

In some embodiments, the angled portions 648 may be integral with the transverse portion 650 such that the angled portions 648 and the transverse portion 650 of each of the chain insert portions 632 is made of a continuous material. In some alternative embodiments, the angled portions 648 and the transverse portion 650 of each one of the chain insert portions 632 may not be made of a continuous material and may instead be separate parts or components that are fastened together by fasteners.

The chain insert 622 is installed on the barrel structure 624 of the barrel 620 of the feedroll 602 by inserting the transverse portions 650 into the chain insert slots 640 of the first and second chain insert mount portions 636a, 636b and wrapping the chain insert 622 around the barrel structure 624 within the chain insert region 635. Once the transverse portions 650 are inserted into the chain insert slots 640 and the chain insert 622 is wrapped around the barrel structure 624 at and within the chain insert region 635, the first and last ones of the chain insert portions 632 of the chain insert 622 are fastened together by one or more fasteners 652. The one or more fasteners 652 may include one or more bolts, one or more nuts, or one or more various fastener components for fastening the first and last one of the chain insert portions 632 together. Fastening the first and last one of the chain insert portions 632 of the chain insert 622 results in the chain insert 622 being wrapped around the barrel structure 624 and held in place on the barrel structure 624 by the chains insert slots 640 and the one or more fasteners 652. The one or more fasteners 652 may be more readily seen in FIG. 8E of the present disclosure and may pass through one or more fastener openings in the first and last one of the chain insert portions 632 to fasten the first and last one of the chain insert portions 632 together. In other words, once the chain insert 622 is wrapped around the barrel 620 and the one or more fasteners 652 fasten together the first and last one of the chain insert portions 632, the compression force of the chain insert 622 on the barrel 620 and the fastening force of the one or more fasteners 652 results in the chain insert 622 being mounted to the feedroll 602 in a wrapped fashion. To remove the chain insert 622 from the barrel 620, a maintenance employe may easily and quickly remove the one or more fasteners 652 such that chain insert 622 may then be unwrapped and removed from the barrel 620. The first and last one of the chain insert portions 632 may each include a fastening reception structure that are structured to receive the one or more fasteners 652 to fasten together the first and last one of the chain insert portions 632 when mounting the chain insert 622 to a respective barrel or barrel structure (e.g., the barrel 620).

The chain insert portion 632 that are coupled together between the first and last one of the chain insert portions 632 may be referred to as intermediate chain insert portions 632. These intermediate chain insert portions 632 may be permanently coupled together, may be semi-permanently coupled together, or may be coupled together by one or more fasteners to form the chain insert 622.

If the chain insert 622 is to be replaced at the end of its usable life span or removed when performing maintenance (e.g., remove left over wood material present between the chain insert 620 and the barrel 620), the chain insert 622 may be easily and quickly removed by removing the one or more fasteners. For example, if the chain insert 622 were to be permanently affixed or integral the barrel 620 of the feedroll, the entire feedroll 602 would instead have to be replaced. However, as the chain insert 622 is not permanently affixed and is removably coupled or mounted to the barrel 620, the chain insert 622 may be easily and quickly replaced. This ease in removing and replacement of the chain insert decreases maintenance time and downtime of the driving mechanism or system 600. This reduction in maintenance time and downtime of the driving mechanism or system 600 increases yield of processed timber output by the debarker in which the driving mechanism or system 600 with the feedrolls 602 having the chain inserts 622.

As the chain insert 622 generally deteriorates more quickly than the barrel 620 of the feedroll 602, the chain insert 622 may simply be replaced multiple times utilizing the same barrel 620 reducing expenses in replacing parts at the end of their usable lifespan. For example, if the chain insert 622 and the barrel 620 were integral and permanently affixed or semi-permanently fixed (e.g., tack welded) to each other, the entire feedroll 602 would need to be replaced, which would be a much more expensive and timely process than simply removing and replacing only the chain insert 622 as discussed herein. In other words, as fewer parts are replaced when performing this maintenance and the ease of replacing those parts is straightforward and simple, maintenance expenses and costs as well as downtime of the debarking mechanism or systems 600, 618 are reduced when utilizing the feedroll 602 with the chain insert 622.

While the chain insert 622 is fully removable and replaceable from the barrel 620 of the feedroll, 602, in some alternative embodiments, each chain insert portion 632 of the chain insert 622 may be individually removable and replaceable. For example, in some embodiments, each one of the plurality of pins 634 may be removable such that individual ones of the chain insert portions 632 may be removed and replaced individually.

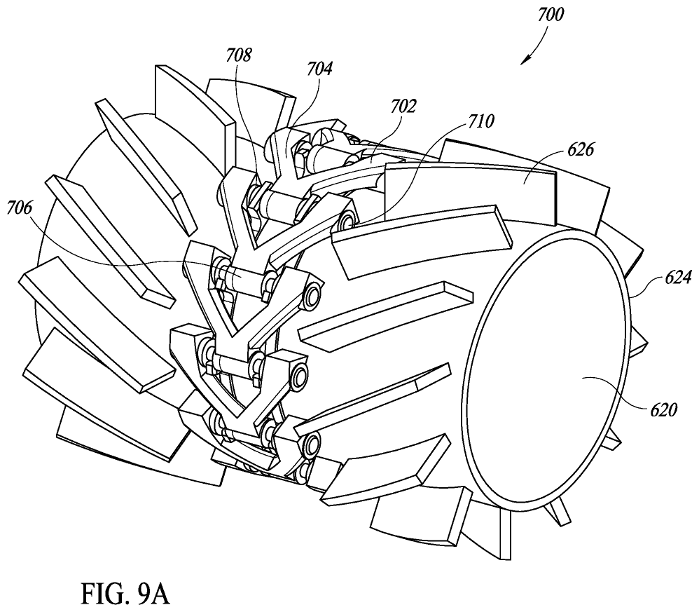

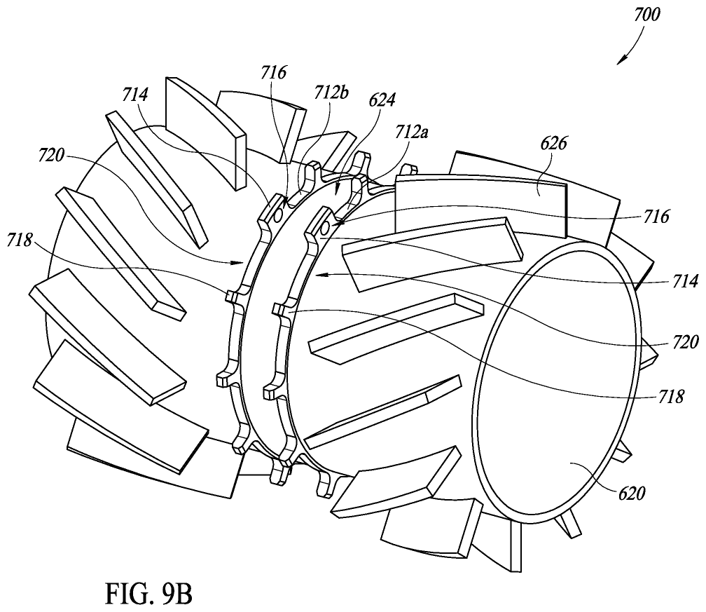

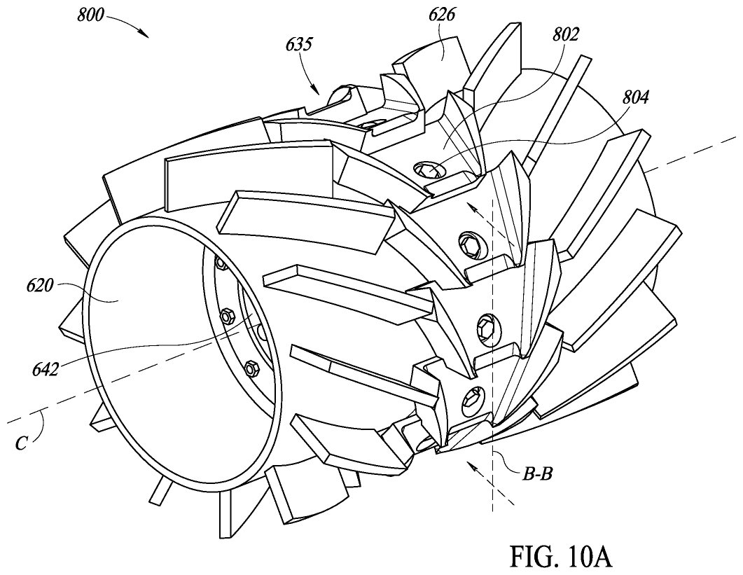

FIG. 9A is a perspective view of an alternative embodiment of a feedroll 700. FIG. 9B is a perspective view of the feedroll 700 with a chain insert 702 removed from the barrel 620 of the feedroll 700. The same or similar features of the feedroll 700 relative to the feedroll 602 are provided with the same or similar reference numerals. The following discussion will focus on additional and different features of the feedroll 700 relative to the feedroll 602. The feedroll 700 may be utilized in the driving mechanisms or systems 600, 618 of the present disclosure instead of the feedroll 602.

The feedroll 700 includes a chain insert 702 that is mounted on the barrel 620 of the feedroll 700. The chain insert 702 includes one or more chain insert portions 704 that are coupled together to form the chain insert 702. The chain insert 702 is wrapped around the barrel 620 in a similar fashion as the chain insert 622 is wrapped around the barrel 620.

Each one of the one or more chain insert portions 704 includes angled portions 648, a first fastening end 706 at a point at which the angled portions 648 meet, a second fastening end 708 at an end of one of the angled portions 648, and a third fastening end 710 at an end of the opposite one of the angled portions 648.

Adjacent ones of the chain insert portions 704 are coupled together by inserting a pin or fastener in the first fastening end 706 and into the second and third fastening ends 708, 710 of another one of the chain insert portions 704. In this embodiment, the first and last one of the chain insert portions 704 of chain insert 702 are not fastened together when wrapped onto the barrel 620.

As shown in FIG. 9B, the barrel 620 includes a first chain insert mount portion 712a and a second chain insert mount portion 712b that is opposite to the first chain insert mount portion 712a. The first and second chain insert mount portions 712a, 712b define the chain insert region 635. The first and second chain insert mount portions 712a, 712b both include a chain insert fastening structure 714. Each one of the chain insert fastening structures 714 includes a through hole 716. The first and second chain insert mount portions 712a, 712b include protrusions or extensions 718, which in some embodiments may be structured as hooks, and include recessed regions 720 between the protrusions or extensions 718.

When mounting the chain insert 702 to the barrel 620, each one of the chain insert portions 704 is inserted into a corresponding one of the recessed regions 720 of the first and second chain insert mount portions 712a, 712b. Each one of the chain insert portions 704 may be held in place and abut the protrusions or extensions 718 such that each one of the chain insert portions 704 is properly placed and positioned along the barrel 620. Once the chain insert portions 704 are positioned along the first and second chain insert mount portions 712a, 712b, a fastener or pin is inserted through the second and third ends 708, 710 of the fastening ends of the respective chain insert portion 704 (e.g., first chain insert portion) at a first end of the chain insert 702, is inserted through the through holes 716 extending through the chain insert fastening structures 714, and is inserted into the first fastening end 706 of the respective chain insert portion 704 (e.g., last chain insert portion) at a second end of the chain insert 702 opposite to the first end. Inserting the fastener or pin through these various features results in the chain insert 702 being wrapped around and mounted to the barrel 620. After being mounted to the barrel 620, the chain insert 702 may be easily and quickly removed from the barrel 620 by removing the fastener or pin that was inserted through the second and third ends 708, 710 of the fastening ends of the respective chain insert portion 704 at the first end of the chain insert 702, was inserted through the through holes 716 extending through the chain insert fastening structures 714, and was inserted into the first fastening end 706 of the respective chain insert portion 704 at a second end of the chain insert 702 opposite to the first end. For example, the chain insert 702 may be removed after being mounted to the barrel once it reaches the end of its usable life span or is being replaced due to being damaged when in use within the driving mechanism or system 600 to drive respective logs through a debarker.

The chain insert 702 is removably mounted to the barrel 620 such that the chain insert 702 may be removed to be repaired or replaced during maintenance of at least one of the driving mechanisms or systems 600, 618, respectively, of the present disclosure. For example, if one of the chain inserts 702 is broken, a maintenance employee may remove the broken chain insert 702 from the feedroll 700 and replace it with a new chain insert 702. This replacement process of the chain insert 702 prevents the maintenance employee from having to remove and replace the entire feedroll 700. This replacement of only the chain insert 702 when broken or at the end of its usable life span reduces maintenance costs, reduces downtime, and reduces replacement part costs as instead of having to remove and replace the entire feedroll 700 only the chain insert 702 needs to be removed and replaced when broken or worn. In other words, maintenance time is reduced, because if the entire feedroll 700 were to be removed and replaced it may take an hour or longer to replace the entire feedroll 700, whereas only removing and replacing the chain insert 702 may take less time.

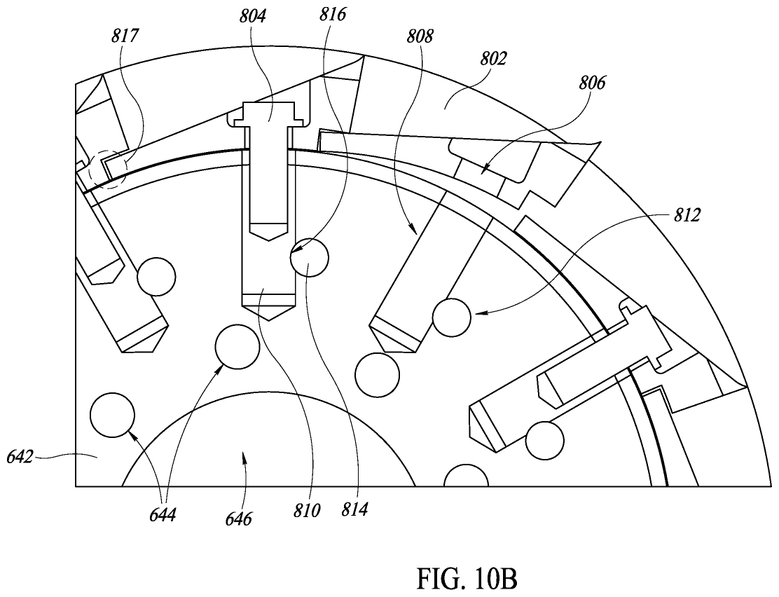

FIG. 10A is a perspective view of an alternative embodiment of a feedroll 800 of the present disclosure. FIG. 10B is a cross-sectional view of the alternative embodiment of the feedroll 800 as shown in FIG. 10A taken along line B-B as shown in FIG. 10A. The same or similar of the features of the feedroll 800 relative to the feedrolls 602, 700 are provided with the same or similar reference numerals. The following discussion will focus on additional and different features of the feedroll 800 relative to the feedrolls 602, 700. The feedroll 800 may be utilized in the driving mechanisms or systems 600, 618 instead of the feedrolls 602, 700.

The feedroll 800 includes a plurality of flute portions 802 that are mounted to the barrel 620 between a first group and a second group of the barrel flutes 626 of the barrel 620 on opposite sides of an insert region 635. In this embodiment, each one of the plurality of flute portions 802 may be an individual flute portion that is individually mounted and individually replaceable. Each one of the plurality of flute portions 802 is individually mounted to the barrel 620 by fasteners 804 that are inserted through openings or through holes 806 in each one of the plurality of flute portions 802. For example, each flute portion 802 is mounted to the barrel 620 by inserting a corresponding fastener 804 through an opening 806 in the corresponding flute portion 802.

The barrel 620 includes fastening reception holes 808 that receive fastener receiving structures 810 and transverse reception holes 812 that receive transverse pins or fasteners 814. When mounting the flute portions 802 to the barrel 620, the fastener receiving structures 810 are inserted into the fastening reception holes 808. After the fastener receiving structures 810 are positioned within the fastening reception holes 808, the transverse pins or fasteners 814 are inserted into the transverse reception holes 812. Each of the transverse pins or fasteners 814 engages with a surface 816, which is curved in this embodiment, of a corresponding one of the fastening reception structures 810 such that the fastening reception structures 810 are held in place within the fastening reception holes 808. After the fastening reception structures 810 and the transverse pins or fasteners 814, respectively, are positioned within the fastening reception holes 808 and the transverse reception holes 812, respectively, the flute portions 802 are individually positioned on the barrel 620 such that the fasteners 804 may be passed through the openings or through holes 806 such that the fasteners 804 engage with corresponding ones of the fastening reception structures 810 mounting the flute portions 802 to the barrel 620 within the insert region 635.

In the embodiment as shown in FIGS. 10A and 10B, the fastening reception holes 808 are perpendicular to a central axis C (see FIG. 10A) and the transverse reception holes 812 are parallel with the central axis C.

As shown in FIG. 10B, one of the fasteners 804, the fastening reception structures 810, and the transverse pins or fasteners 814 is hidden such that at least one of the fastening reception holes 808 and one of the transverse reception holes 812 is more readily visible.

When at least one of the flute portions 802 is to be removed or replaced from the barrel structure 620, the fastener 804 fastening the at least one flute portion 802 to the barrel 620 is removed. For example, while the flute portions 802 may slightly overlap each other as shown in FIG. 10B at regions 817, the flute portion 802 being removed may slide out and a new replacement flute portion 802 may slide into place and mounted to barrel 620 by passing the fastener 804 through the opening or through hole 806 of the new replacement flute portion 802 fastening the new replacement flute portion 802 to the barrel 620.

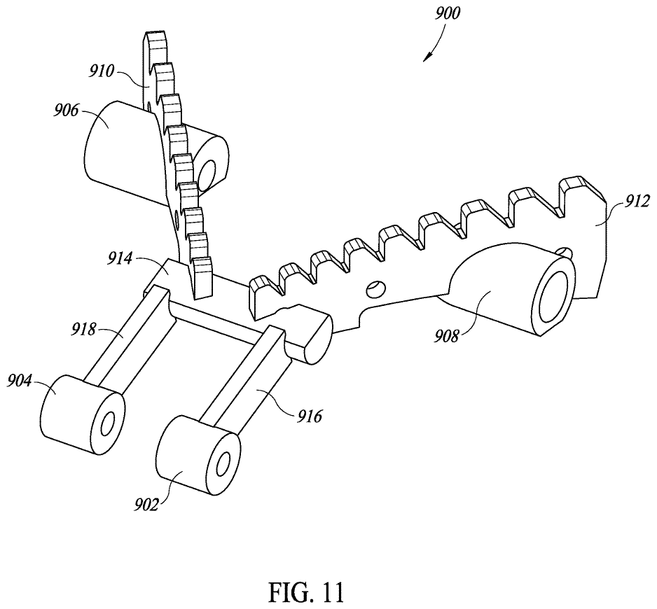

FIG. 11 is a perspective view of an alternative embodiment of a chain insert portion or flute 900 of the present disclosure. The chain insert portion 900 includes a first reception structure 902, a second reception structure 904, a third reception structure 906 and a fourth reception structure 908. The chain insert portion 900 includes a first angled portion 910 and a second angled portion 912. The first and second angled portions 910, 912 are coupled to a transverse portion 914 that couples together the first angled portion 910 and the second angled portion 912. The third reception structure 906 is coupled to the first angled portion 910, and the fourth reception structure 908 is coupled to the second angled portion 912. The first reception structure 902 is coupled to the transverse portion 914 by a first extension 916 and the second reception structure 904 is coupled to the transverse portion 914 by a second extension 918. When forming a chain insert, multiple ones of the chain insert portion 900 may be coupled together to form a chain insert, for example, by passing fasteners or pins into ones of the first, second, third, and fourth reception structures 902, 904, 906, 908. For example, a pair of the chain insert portions 900 including a first chain insert portion and a second chain insert portion may be coupled together by aligning the first and second reception structures 902, 904 of the first chain insert portion with the third and fourth reception structures 906, 908 of the second chain insert portion. Once these respective reception structures of the chain insert portions 902, 904, 906, 908 are aligned with each other, one or more fasteners or pins are passed into and through the first and second reception structures 902, 904 of the first chain insert portion and the third and fourth reception structures 906, 908 of the second chain insert portion coupling together the first and second chain insert portions of the pair of chain insert portions. This may be done multiple times such that multiple ones of the chain insert portion 900 are coupled together forming a chain insert that may be mounted to a barrel of a feedroll of an embodiment of the present disclosure.

At least one embodiment of a centering mechanism for a debarker of the present disclosure may be summarized as including: a plurality of rollers having a first position and a second position, the plurality of rollers configured to, in operation, move between the first position and the second position to abut an outer surface of a respective log and to direct and center the respective log through the debarker; and a closed loop control system including: a hydraulic actuator configured to, in operation, move the plurality of rollers between the first position and the second position; a plurality of fluid lines in fluid communication with the hydraulic actuator, the plurality of fluid lines configured to, in operation, carry hydraulic fluid to the hydraulic actuator to move the plurality of rollers; a plurality of pressure transducers along the plurality of fluid lines, the plurality of pressure transducers configured to, in operation, monitor respective pressures along the plurality of fluid lines; a position transducer configured to, in operation, monitor an actuation position of the hydraulic actuator; and a controller in electrical communication with the plurality of pressure transducers and the position transducer, the controller configured to, in operation, output electrical signals to control the hydraulic actuator to actuate the plurality of rollers.

The centering mechanism may further include: a plurality of roller arms coupled to the plurality of rollers, wherein each respective roller arm of the plurality of roller arms is coupled to a corresponding roller of the plurality of rollers; a plurality of roller pivots, each respective roller arm of the plurality of roller arms rotates about a corresponding roller pivot point of the plurality of roller pivot; a plurality of arms in mechanical cooperation with the roller pivots; and a linkage structure including: a plurality of pivot ends in mechanical cooperation with the roller pivots; and an actuation end in mechanical cooperation with the hydraulic actuator.

The centering mechanism may further include a log scanning device downstream or upstream of the plurality of rollers, the log scanning device is configured to, in operation, scan a diameter to the respective log before the respective log is between the plurality of rollers.

The log scanning device is in electrical communication with the controller.

The controller is configured to, in operation, receive a first data signal from the log scanning device, determine the diameter of the respective log, and output a first control signal to provide the hydraulic fluid to the hydraulic actuator to pre-position the plurality of rollers in advance of the respective log passing between the plurality of rollers.

After the respective log begins to pass between the plurality of rollers, the plurality of pressure transducers may be configured to, in operation, output second data signals to the controller representative of respective pressures along a plurality of hydraulic lines; after the respective log begins to pass between the plurality of rollers, an actuation transducer may be configured to, in operation, output a third data signal to the controller representative of the actuation position of the hydraulic actuator; and the controller may be configured to, in operation, receive the second data signals and the third data signals and output a control signal to adjust the actuation position of the hydraulic actuator to move the plurality of rollers.

The controller may be configured to, in operation, adjust the actuation position of the hydraulic actuator to move the plurality of rollers such that respective pressures within the plurality of fluid lines are within one or more target ranges or substantially equal to one or more target pressures.

At least one embodiment of a method of the present disclosure may be summarized as including: before a first log is between a plurality of rollers of a centering mechanism of a debarker, scanning the log with a log scanning device and outputting a first data signal to a controller; before the first log is between the plurality of rollers of the centering mechanism, determining a respective diameter of the log with the controller by analyzing the first data signal; before a second log is between the plurality of rollers, positioning the plurality of rollers to an initial position with a hydraulic actuator based on the respective diameter of the second log; after the first log is between the plurality of rollers and the plurality of rollers abut an outer surface of the second log, monitoring a pressure within the hydraulic actuator with one or more pressure transducers; and after the first log is between the plurality of rollers and the plurality of rollers abut and roll along the outer surface of the second log, controlling the pressure within the hydraulic actuator to be within a targeted pressure range.

Controlling the pressure within the hydraulic actuator to be within a targeted pressure may further result in maintaining a force by the plurality of rollers applied to the outer surface of the first log and the second log to be within a targeted force range.

Positioning the plurality of rollers to the initial position may include at least one of the following of: moving the rollers away from a first position closer to a center of the centering mechanism and moving the rollers towards a second position further from the center of the centering mechanism; and moving the rollers toward the first position and moving the rollers away from the second position.

At least one embodiment of a feedroll of the present disclosure may be summarized as including: a barrel including: a chain flute insert region; a plurality of flutes including a first group on a first side of the chain flute insert region and a second group on a second side of the chain flute insert region opposite to the first region; a first chain insert mount portion between the first group of the plurality of flutes and the chain flute insert region; a second chain insert mount portion between the second group of the plurality of flutes and the chain flute insert region; a chain flute insert wrapped around and removably coupled to the barrel at the chain flute insert region.

At least one embodiment of a feedroll of the present disclosure may be summarized as including: a barrel including: a central axis; a flute insert region; a plurality of flutes including a first group on a first side of the chain flute insert region and a second group on a second side of the chain flute insert region opposite to the first region; a plurality of fastening reception holes extending into the flute insert region towards the central axis; a plurality of transverse reception holes extending into the barrel and being parallel to the central axis, each respective transverse reception hole of the plurality of transverse reception holes overlapping a corresponding fastening reception hole of the plurality of fastening reception holes; a plurality of fastening receiving structures inserted into the plurality of fastening reception holes; a plurality of transverse pins inserted into the plurality of transverse reception holes, the plurality of transverse pins mechanically engage with the plurality of fastening receiving structures; a plurality of flute portions within the flute insert region, each respective flute portion of the plurality of flutes portions includes a through hole aligned with a corresponding fastening reception structure; and a plurality of fasteners inserted through the through holes of the plurality of flutes portions and inserted into the plurality of fastening receiving structures to couple the plurality of flute portions to the barrel.

At least one embodiment of a chain insert of the present disclosure may be summarized as including: a plurality of chain insert flute portions including: a first end; a second end; a first chain insert flute portion at the first end, the first chain insert portion including a first fastening reception structure; a second chain insert flute portion at the second end, the second chain insert portion including a second fastening reception structure; and an intermediate chain insert flute portion between the first end and the second end, and wherein the first fastening reception structure of the first chain insert flute portion and the second fastening reception structure of the second chain insert flute portion are configured to, in operation, be receive a fastener to fasten the first chain insert flute portion to the second chain insert portion.

The first fastening reception structure of the first chain insert flute portion and the second fastening reception structure of the second chain insert flute portion may be configured to, in operation, receive the fastener to fasten the first chain insert flute portion to the second chain insert portion when mounting the chain insert to a barrel structure.

The various embodiments described above can be combined to provide further embodiments. Aspects of the embodiments can be modified, if necessary to employ concepts of the various patents, applications and publications to provide yet further embodiments. The present application claims priority to U.S. Provisional Application No. 63/500,460 filed on May 5, 2023 in the United States Patent Office, the entire contents and disclosure of which are incorporated herein by reference.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A centering mechanism for a debarker, comprising:
a plurality of rollers having a first position and a second position, the plurality of rollers configured to, in operation, move between the first position and the second position to abut an outer surface of a respective log and to direct and center the respective log through the debarker; and
a closed loop control system including:
a hydraulic actuator configured to, in operation, move the plurality of rollers between the first position and the second position;
a plurality of fluid lines in fluid communication with the hydraulic actuator, the plurality of fluid lines configured to, in operation, carry hydraulic fluid to the hydraulic actuator to move the plurality of rollers;
a plurality of pressure transducers along the plurality of fluid lines, the plurality of pressure transducers configured to, in operation, monitor respective pressures along the plurality of fluid lines;
a position transducer configured to, in operation, monitor an actuation position of the hydraulic actuator; and
a controller in electrical communication with the plurality of pressure transducers and the position transducer, the controller configured to, in operation, output electrical signals to control the hydraulic actuator to actuate the plurality of rollers.

2. The centering mechanism of claim 1, further comprising:
a plurality of roller arms coupled to the plurality of rollers, wherein each respective roller arm of the plurality of roller arms is coupled to a corresponding roller of the plurality of rollers;
a plurality of roller pivots, each respective roller arm of the plurality of roller arms rotates about a corresponding roller pivot point of the plurality of roller pivot;
a plurality of arms in mechanical cooperation with the roller pivots; and
a linkage structure including:
a plurality of pivot ends in mechanical cooperation with the roller pivots; and
an actuation end in mechanical cooperation with the hydraulic actuator.

3. The centering mechanism of claim 1, further comprising a log scanning device downstream or upstream of the plurality of rollers, the log scanning device is configured to, in operation, scan a diameter to the respective log before the respective log is between the plurality of rollers.

4. The centering mechanism of claim 3 wherein the log scanning device is in electrical communication with the controller.

5. The centering mechanism of claim 4, wherein the controller is configured to, in operation, receive a first data signal from the log scanning device, determine the diameter of the respective log, and output a first control signal to provide the hydraulic fluid to the hydraulic actuator to pre-position the plurality of rollers in advance of the respective log passing between the plurality of rollers.

6. The centering mechanism of claim 5, wherein:
after the respective log begins to pass between the plurality of rollers, the plurality of pressure transducers is configured to, in operation, output second data signals to the controller representative of respective pressures along a plurality of hydraulic lines;
after the respective log begins to pass between the plurality of rollers, an actuation transducer is configured to, in operation, output a third data signal to the controller representative of the actuation position of the hydraulic actuator; and
the controller is configured to, in operation, receive the second data signals and the third data signals and output a control signal to adjust the actuation position of the hydraulic actuator to move the plurality of rollers.

7. The centering mechanism of claim 6, wherein the controller is configured to, in operation, adjust the actuation position of the hydraulic actuator to move the plurality of rollers such that respective pressures within the plurality of fluid lines are within one or more target ranges or substantially equal to one or more target pressures.

8. A method, comprising:
before a first log is between a plurality of rollers of a centering mechanism of a debarker, scanning the log with a log scanning device and outputting a first data signal to a controller;
before the first log is between the plurality of rollers of the centering mechanism, determining a respective diameter of the log with the controller by analyzing the first data signal;
before a second log is between the plurality of rollers, positioning the plurality of rollers to an initial position with a hydraulic actuator based on the respective diameter of the second log;
after the first log is between the plurality of rollers and the plurality of rollers abut an outer surface of the second log, monitoring a pressure within the hydraulic actuator with one or more pressure transducers; and
after the first log is between the plurality of rollers and the plurality of rollers abut and roll along the outer surface of the second log, controlling the pressure within the hydraulic actuator to be within a targeted pressure range.

9. The method of claim 8, wherein controlling the pressure within the hydraulic actuator to be within a targeted pressure further results in maintaining a force by the plurality of rollers applied to the outer surface of the first log and the second log to be within a targeted force range.

10. The method of claim 8, wherein positioning the plurality of rollers to the initial position includes at least one of the following of:
moving the rollers away from a first position closer to a center of the centering mechanism and moving the rollers towards a second position further from the center of the centering mechanism; and
moving the rollers toward the first position and moving the rollers away from the second position.

11. A feedroll, comprising:
a barrel including:
a chain flute insert region;
a plurality of flutes including a first group on a first side of the chain flute insert region and a second group on a second side of the chain flute insert region opposite to the first region;
a first chain insert mount portion between the first group of the plurality of flutes and the chain flute insert region;
a second chain insert mount portion between the second group of the plurality of flutes and the chain flute insert region;
a chain flute insert wrapped around and removably coupled to the barrel at the chain flute insert region.

12. A feedroll, comprising:
a barrel including:
a central axis;
a flute insert region;
a plurality of flutes including a first group on a first side of the chain flute insert region and a second group on a second side of the chain flute insert region opposite to the first region;
a plurality of fastening reception holes extending into the flute insert region towards the central axis;
a plurality of transverse reception holes extending into the barrel and being parallel to the central axis, each respective transverse reception hole of the plurality of transverse reception holes overlapping a corresponding fastening reception hole of the plurality of fastening reception holes;
a plurality of fastening receiving structures inserted into the plurality of fastening reception holes;
a plurality of transverse pins inserted into the plurality of transverse reception holes, the plurality of transverse pins mechanically engage with the plurality of fastening receiving structures;
a plurality of flute portions within the flute insert region, each respective flute portion of the plurality of flutes portions includes a through hole aligned with a corresponding fastening reception structure; and
a plurality of fasteners inserted through the through holes of the plurality of flutes portions and inserted into the plurality of fastening receiving structures to couple the plurality of flute portions to the barrel.

13. A chain insert, comprising:
a plurality of chain insert flute portions including:
a first end;
a second end;
a first chain insert flute portion at the first end, the first chain insert portion including a first fastening reception structure;
a second chain insert flute portion at the second end, the second chain insert portion including a second fastening reception structure; and
an intermediate chain insert flute portion between the first end and the second end,
wherein the first fastening reception structure of the first chain insert flute portion and the second fastening reception structure of the second chain insert flute portion are configured to, in operation, be receive a fastener to fasten the first chain insert flute portion to the second chain insert portion.

14. The chain insert of claim 13, wherein the first fastening reception structure of the first chain insert flute portion and the second fastening reception structure of the second chain insert flute portion are configured to, in operation, receive the fastener to fasten the first chain insert flute portion to the second chain insert portion when mounting the chain insert to a barrel structure.
